(19) United States
(12) Patent Application Publication
(10) Pub. No.: US 2016/0156515 A1
(43) Pub. Date: Jun. 2, 2016

(54) MANAGEMENT DEVICE AND CLOUD SYSTEM

(71) Applicant: FUJITSU LIMITED, Kawasaki-shi (JP)

(72) Inventors: Hiroyuki Ito, Numazu (JP); Yuuki Tanabe, Numazu (JP); Yoichiro Iura, Numazu (JP); Yuusuke Shimada, Numazu (JP); Yoshinori Kadosaki, Numazu (JP); Yoshitaka Kizuka, Fuji (JP)

(73) Assignee: FUJITSU LIMITED, Kawasaki-shi (JP)

(21) Appl. No.: 14/950,438

(22) Filed: Nov. 24, 2015

(30) Foreign Application Priority Data
Nov. 28, 2014 (JP) 2014-241639

(51) Int. Cl. H04L 12/24; H04L 29/08

(52) U.S. Cl. CPC H04L 41/0813; H04L 41/0893; H04L 41/142; H04L 67/1031

(57) ABSTRACT

A virtual resource information storing unit stores therein information on physical network device in which each virtual resource is arranged and a physical device information storing unit stores therein the number of remaining definitions of each of the physical network devices. When the device management unit is not able to add to a virtual resource arranged in a physical network device, the device management unit rearranges the virtual resource to another physical network device by using the virtual resource information storing unit and the physical device information storing unit.

### CROSS-REFERENCE TO RELATED APPLICATION(S)

This application is based upon and claims the benefit of priority of the prior Japanese Patent Application No. 2014-241639, filed on Nov. 28, 2014, the entire contents of which are incorporated herein by reference.

### FIELD

The embodiment discussed herein is related to a management device and a cloud system.

### BACKGROUND

In recent years, attention is paid to a technology that controls a network, such as Software Defined Networking (SDN), by using software without being aware of individual physical network device. There is a cloud environment for multi tenants, as an area, that uses the technology, such as SDN or the like. In the cloud environment for multi tenants, a physical network device that has a function of, for example, firewall, Server Load Balancing (SLB), or the like is virtually divided into multiple network devices and the divided network devices are separately provided to the individual tenants.

When the virtual network devices are used, an administrator of a cloud system (hereinafter, referred to as a “cloud administrator”) sets definitions of virtual network device used for each tenant in the physical network device as a single combined definition such that inconsistency does not occur.

Note that, as a technology related to multi tenants, there is a conventional technology that guarantees independence of the setting between tenants and between network devices by automatically calculating design items that are set in the network devices used by the tenants such that no overlap is present between the tenants.

Furthermore, there is a conventional technology, when the configuration of a virtual server for a tenant is changed in an information processing system with a multi-tenant type, that promptly identifies a setting change item and setting target NW device from a tenant identifier, a use mode of a virtual server, and a segment condition.

Patent Document 1: Japanese Laid-open Patent Publication No. 2012-253550

Patent Document 2: Japanese Laid-open Patent Publication No. 2012-65015

When the virtual network device is used, because a system operator of the tenant requests to add a definition of the virtual network device without recognizing a free space for the number of available definitions of the physical network device, there may be a case in which a definition is not able to be added due to constraint of the upper limit of the number of definitions of the physical network device. In this case, the cloud administrator searches for a physical network device that has a free space for the number of definitions and migrates the arranged virtual network device.

Consequently, there is a problem in that, when the system operator of the tenant adds the definition of the virtual network device, it needs an effort for a cloud administrator's work and a tenant is not able to use the system until the cloud administrator's work is ended.

### SUMMARY

According to an aspect of an embodiment, a management device includes a determining unit that determines, in a physical network device in which a virtual network device targeted for setting is arranged, whether the number of network definitions that can be used by the virtual network device can be added; and a rearranging unit that selects, when the determining unit determines that no addition can be made, on the basis of a state of the number of network definitions of the virtual network device targeted for the setting and another virtual network device that is arranged in the physical network device, virtual network device to be migrated to another physical network device and that rearranges the virtual network device arranged in the physical network device.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1A is a schematic diagram illustrating an initial arrangement of virtual resources;

FIG. 1B is a schematic diagram illustrating an arrangement of the virtual resources after rearrangement;

FIG. 2 is a schematic diagram illustrating the physical configuration of a cloud system according to an embodiment;

FIG. 3 is a schematic diagram illustrating the system configuration viewed from a cloud user;

FIG. 4 is a schematic diagram illustrating the configuration of a physical FW device;

FIG. 5 is a schematic diagram illustrating an example of log information stored in a log information storing unit in the physical FW device;

FIG. 6 is a schematic diagram illustrating an example of definition information stored in a definition information storing unit in the physical FW device;

FIG. 7 is a schematic diagram illustrating the configuration of a physical SLB device;

FIG. 8 is a schematic diagram illustrating an example of statistical information stored in a statistical information storing unit in the physical SLB device;

FIG. 9 is a schematic diagram illustrating an example of definition information stored in a definition information storing unit in the physical SLB device;

FIG. 10 is a schematic diagram illustrating the configuration of a cloud management device;

FIG. 11 is a schematic diagram illustrating an example of virtual resource information stored in a virtual resource information storing unit;

FIG. 12 is a schematic diagram illustrating an example of physical device information stored in a physical device information storing unit;

FIG. 13 is a schematic diagram illustrating an example of history information stored in a history information storing unit;

FIG. 14 is a schematic diagram illustrating an example of save information stored in a save information storing unit;

FIG. 15 is a schematic diagram illustrating an example of holding period information stored in a holding period information storing unit;

FIG. 16 is a schematic diagram illustrating an example of conversion information stored in a conversion information storing unit;

FIG. 17 is a schematic diagram illustrating a combination of log information;

FIG. 18 is a schematic diagram illustrating a combination of statistical information;

FIG. 19A is a flowchart illustrating the flow of a setting addition process;

FIG. 19B is a flowchart illustrating the flow of a setting addition process;

FIG. 19C is a flowchart illustrating the flow of a setting addition process;

FIG. 19D is a flowchart illustrating the flow of a setting addition process;

FIG. 19E is a flowchart illustrating the flow of a setting addition process;

FIG. 19F is a flowchart illustrating the flow of a setting addition process;

FIG. 20A is a flowchart illustrating the flow of a statistical information acquiring process;

FIG. 20B is a flowchart illustrating the flow of a statistical information acquiring process;

FIG. 21A is a flowchart illustrating the flow of a log information acquiring process;

FIG. 21B is a flowchart illustrating the flow of a log information acquiring process; and

FIG. 22 is a block diagram illustrating a hardware configuration of a computer that executes a cloud management program according to the embodiment.

### DESCRIPTION OF EMBODIMENT

A preferred embodiment of the present invention will be explained with reference to accompanying drawings. The disclosed technology is not limited to this embodiment.

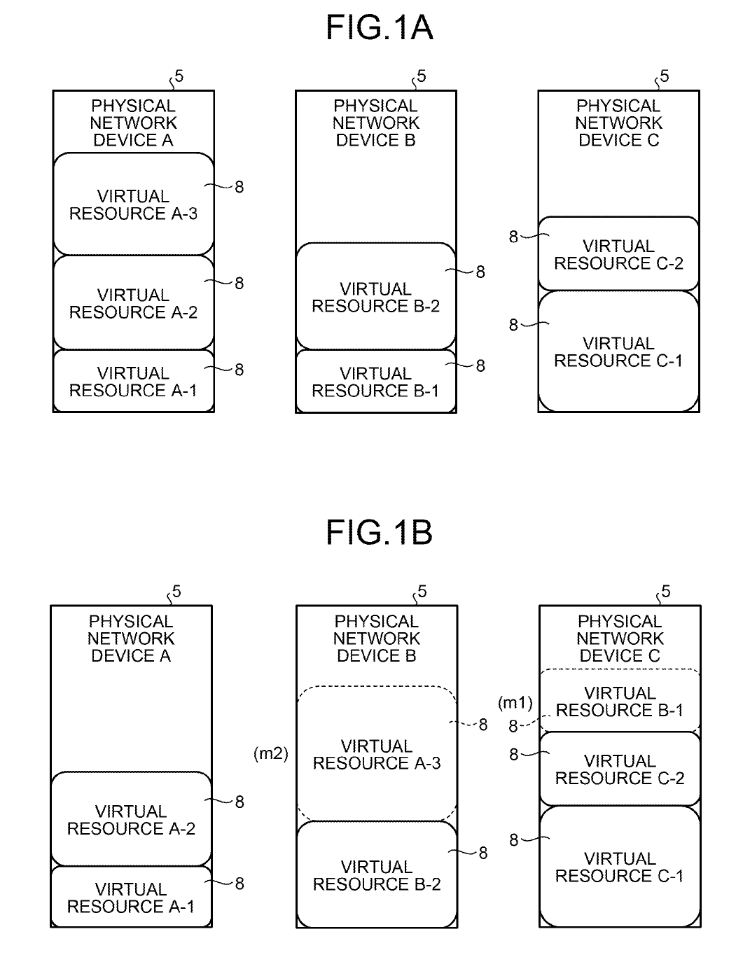

First, rearrangement of a virtual resource performed by a cloud management device according to an embodiment will be described. The virtual resource mentioned here is a virtual network device. FIG. 1A is a schematic diagram illustrating an initial arrangement of virtual resources, and FIG. 1B is a schematic diagram illustrating an arrangement of the virtual resources after rearrangement.

As illustrated in FIG. 1A, as an initial arrangement, it is assumed that seven virtual resources 8 are arranged in three physical network devices 5. In FIG. 1A, the three physical network devices 5 are represented by physical network device A, physical network device B, and physical network device C. Furthermore, the seven virtual resources 8 are represented by virtual resources A-1 to A-3 arranged in the physical network device A, virtual resources B-1 and B-2 arranged in the physical network device B, and virtual resources C-1 and C-2 arranged in the physical network device C. Furthermore, the number of definitions of the resource used by each of the virtual resources 8 is represented by the size of the frames that indicate the respective virtual resources 8. The “definition” mentioned here is, for example, for a firewall device, a setting of a target packet (set by a transmission destination IP address, a port number, or the like) and the setting of whether the packet can be passed, whereas, for a server load balancing device, a setting of distribution of communication addressed to which IP address is delivered to which virtual machine. Furthermore, the “number of definitions” mentioned here is, for example, for a firewall device, the number of target packets to be specified, whereas, for a server load balancing device, the number of settings of distribution of communication addressed to which IP address is delivered to which virtual machine.

Here, if a request for a definition to be added to the virtual resource A-3 is received from a system operator of a tenant and the number of free definitions is insufficient in the physical network device A, the cloud management device according to the embodiment performs the following process.

(1) The cloud management device according to the embodiment determines, as a migration candidate, a physical network device in which the stored number of free definitions (number of remaining definitions) is the maximum. In FIG. 1A, the cloud management device according to the embodiment selects the physical network device B. Here, the number of free definitions=(the maximum value of the number of definitions in a device)−(the sum of the number of definitions consumed by virtual resources in the device).

(2) The cloud management device according to the embodiment calculates to determine, from the number of definitions defined before an update, whether the number of definitions in a device at the migration destination is sufficient. In FIG. 1A, the number of defined definitions in the virtual resource A-3>the number of free definitions in the physical network device B.

(3) Accordingly, the cloud management device according to the embodiment determines that the number of definitions is insufficient.

(4) Thus, the cloud management device according to the embodiment selects, as a migration candidate, a virtual resource that has the maximum number of currently used definitions from a physical network device (assumed to be a physical network device X) that has the maximum number of free definitions.

(5) Then, the cloud management device according to the embodiment determines whether the cloud management device was able to select a migration candidate. In FIG. 1A, the virtual resource B-2 is selected. Accordingly, the cloud management device according to the embodiment determines that the cloud management device was able to select a migration candidate.

(6) Then, the cloud management device according to the embodiment selects, as a candidate for the migration destination, a physical network device (assumed to be a physical network device Y) that has the second greatest number of free definitions on the basis of the stored number of remaining definitions. In FIG. 1A, the physical network device C is selected.

(7) Then, the cloud management device according to the embodiment calculates whether, regarding the migration of two virtual resources, the number of definitions is sufficient. In FIG. 1A, the state is as follows:

the number of defined definitions in the virtual resource A-3<(the number of free definitions in the physical network device B+the number of definitions in the virtual resource B-2)

the number of defined definitions in the virtual resource B-2>the number of free definitions in the physical network device C

(8) Accordingly, the cloud management device according to the embodiment determines, for the migration of these two virtual resources, that the number of free definitions is insufficient in the physical network device Y.

(9) Thus, the cloud management device according to the embodiment excludes the selected virtual resource B-2 from the migration candidate and repeats the process starting from (4) for the other virtual resources.

(10) Namely, the cloud management device according to the embodiment selects, as a migration candidate, a virtual resource that has the maximum number of currently used definitions from a physical network device (i.e., the physical network device X) that has the maximum number of free definitions.

(11) Then, the cloud management device according to the embodiment determines whether the cloud management device was able to select a migration candidate. In FIG. 1A, the virtual resource B-1 is selected.

(12) Then, the cloud management device according to the embodiment selects, as a candidate for the migration destination, a physical network device (i.e., the physical network device Y) that is the second greatest number of free definitions on the basis of the stored number of remaining definitions. In FIG. 1A, the physical network device C is selected.

(13) Then, the cloud management device according to the embodiment calculates whether, regarding the migration of two virtual resources, the number of definitions is sufficient. In FIG. 1A, the state is as follows:

the number of defined definitions in the virtual resource A-3<(the number of free definitions in the physical network device B+the number of definitions in the virtual resource B-1)

the number of defined definitions in the virtual resource B-1<the number of free definitions in the physical network device C

(14) Accordingly, the cloud management device according to the embodiment determines, for the migration, that the number of definitions in the physical network device Y is sufficient.

(15) Thus, the cloud management device according to the embodiment determines to migrate to the physical network device Y.

(16) Then, the cloud management device according to the embodiment determines whether the number of definitions in the physical network device X is sufficient and then determines, in FIG. 1A, that the number of free definitions in the physical network device B is sufficient.

(17) Then, the cloud management device according to the embodiment determines the virtual resources targeted for the migration. Namely, as illustrated in FIG. 1B, the cloud management device according to the embodiment migrates the virtual resource B-1 from the physical network device B to the physical network device C (m1) and migrates the virtual resource A-3 from the physical network device A to the physical network device B (m2).

As described above, when the cloud management device according to the embodiment adds to a virtual resource, if no free space is present in the physical network device in which the virtual resource has been arranged, by rearranging the already arranged virtual resource to another physical network device, the cloud management device can automatically add to a virtual resource.

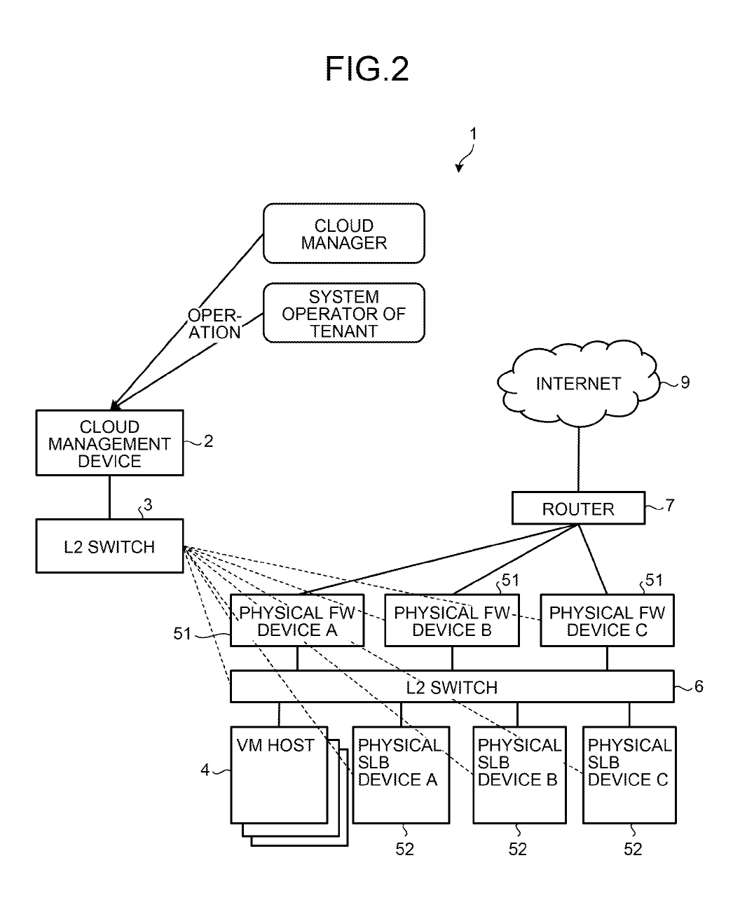

In the following, the configuration of a cloud system according to the embodiment will be described. FIG. 2 is a schematic diagram illustrating a physical configuration of a cloud system according to an embodiment. As illustrated in FIG. 2, a cloud system 1 according to the embodiment includes a cloud management device 2, an L2 switch 3, three VM hosts 4, three physical FW devices 51, three physical SLB devices 52, an L2 switch 6, and a router 7.

Note that, FIG. 2 illustrates, for convenience of description, the three VM hosts 4, the three physical FW devices 51, and the three physical SLB device 52; however, the cloud system 1 may have an arbitrary number of the VM hosts 4, arbitrary number of the physical FW devices 51, and arbitrary number of the physical SLB devices 52. Furthermore, the three physical FW devices 51 are represented by physical FW device A, physical FW device B, and physical FW device C, whereas the three physical SLB devices 52 are represented by physical SLB device A, physical SLB device B, and physical SLB device C. The physical FW device 51 and the physical SLB device 52 are examples of the physical network device 5 illustrated in FIGS. 1A and 1B.

The cloud management device 2 is a device that manages the cloud system 1 on the basis of the operation received from an operation terminal performed by a cloud administrator or a system operator of each tenant. The cloud management device 2 performs arrangement of the virtual resources 8 to the physical network devices 5. Furthermore, when the cloud management device 2 adds to the virtual resource 8, if no free space is present in the physical network device 5 in which the virtual resource 8 is arranged, the cloud management device 2 rearranges an already arranged virtual resource 8 to another physical network device.

The cloud management device 2 is connected to the L2 switch 3 and, as indicated by the broken line illustrated in FIG. 2, is connected to the other device by a management local area network (LAN) via the L2 switch 3. Specifically, the cloud management device 2 is connected to the VM hosts 4, the physical FW device 51, the physical SLB device 52, and the L2 switch 6 by the management LAN.

The L2 switch 3 is a switch for the management LAN and connects, to the cloud management device 2 by the management LAN, the three VM hosts 4, the three physical FW devices 51, the three physical SLB devices 52, and the L2 switch 6.

The VM hosts 4 are physical machines that operate virtual machines. The “machine” mentioned here is a computer. The physical FW device 51 is a firewall device that prevents an unauthorized access to the cloud system 1 from the outside. The physical SLB device 52 is a server load balancing device that performs load distribution to the VM hosts 4.

The L2 switch 6 is a switch for a communication LAN and connects the three VM hosts 4, the three physical FW devices 51, and the three physical SLB devices 52 by the communication LAN. The router 7 is a device that connects the cloud system 1 to the Internet 9 and is connected to the three physical FW devices 51.

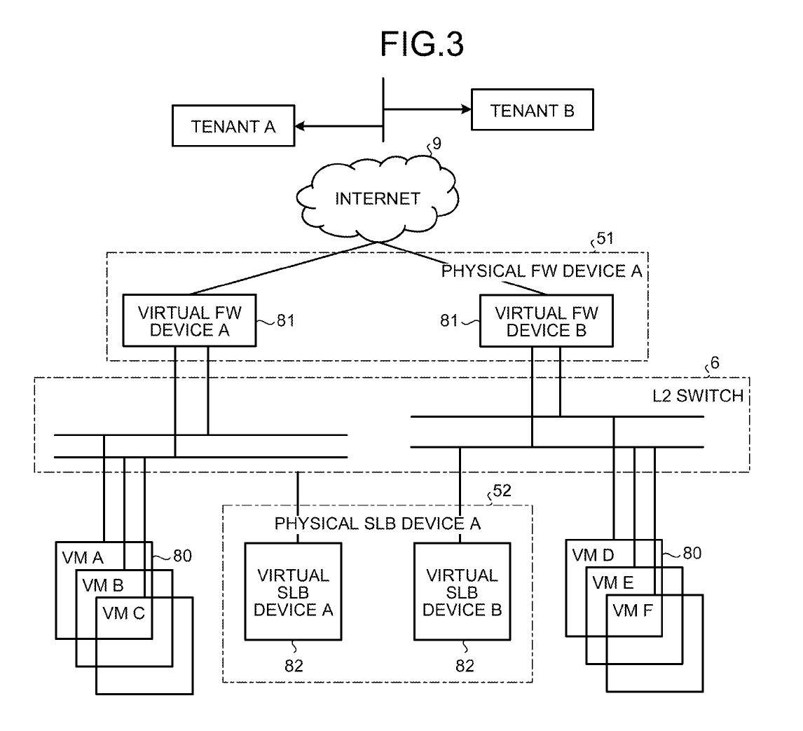

FIG. 3 is a schematic diagram illustrating a system configuration viewed from a cloud user. The “cloud user” mentioned here is a system operator of a tenant. As illustrated in FIG. 3, when viewed from a system operator who is a cloud user of a tenant A, the cloud system 1 includes three VMs 80, a virtual FW device A, and a virtual SLB device A. Furthermore, when viewed from a system operator who is a cloud user of a tenant B, the cloud system 1 includes another three VMs 80, a virtual FW device B, and a virtual SLB device B.

Here, the VMs 80 are virtual machines that are running on the VM hosts 4. Note that, here, a case in which the three VMs 80 are allocated to each of the tenant A and the tenant B is indicated; however, an arbitrary number of the VMs 80 is allocated to each of the tenants. The VMs 80 allocated to the tenant A is represented by a VM A, a VM B, and a VM C, whereas the VMs 80 allocated to the tenant B is represented by a VM D, a VM E, and a VM F.

The virtual FW device A and the virtual FW device B are virtual FW devices 81 running on the physical FW device A. The virtual SLB device A and the virtual SLB device B are virtual SLB devices 82 running on the physical SLB device A.

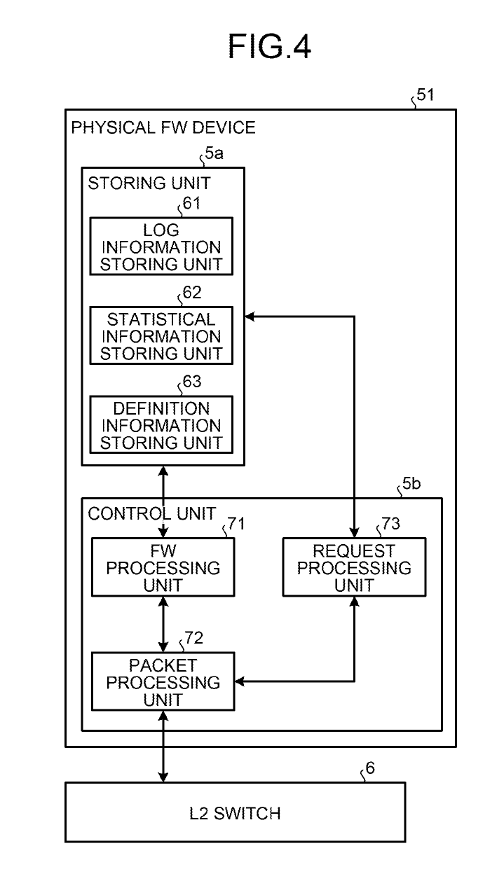

In the following, the configuration of the physical FW device 51 will be described. FIG. 4 is a schematic diagram illustrating the configuration of the physical FW device 51. As illustrated in FIG. 4, the physical FW device 51 includes a storing unit 5a and a control unit 5b. The storing unit 5a is a storage device that stores therein information and includes a log information storing unit 61, a statistical information storing unit 62, and a definition information storing unit 63. The control unit 5b is a control device that controls the physical FW device 51 by using the information stored in the storing unit 5a and includes a FW processing unit 71, a packet processing unit 72, and a request processing unit 73.

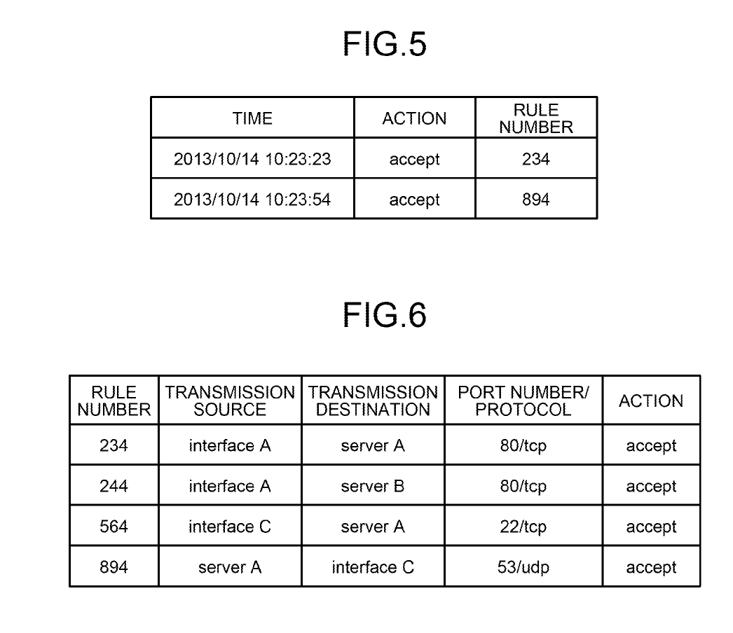

The log information storing unit 61 stores therein log information on the physical FW device 51. FIG. 5 is a schematic diagram illustrating an example of log information stored in the log information storing unit 61. As illustrated in FIG. 5, in the log information, the time, an action, and a rule number are included. The time indicates the time at which the log information is acquired. The action indicates the operation of the physical FW device 51. Examples of the action are reception, blocking, or the like of data specified by a rule.

The rule defines control of an access of the physical FW device 51. An example of the rule includes permission of communication of data having a specific protocol, permission of communication with a specific connection destination, or the like. The rule number is a number for identifying a rule.

For example, the log information storing unit 61 stores therein information indicating that the packet defined by the rule identified by the rule number of “234” is received by the physical FW device 51 at time of “10:23:23 on 2013/10/14”.

The statistical information storing unit 62 stores therein statistical information on the physical FW device 51. Examples of the statistical information are the number of packets specified by a rule, the number of packets in an unauthorized form, the number of attacks that are detected, or the like.

The definition information storing unit 63 stores therein definition information on the physical FW device 51. The definition information mentioned here is information that is used to define the operation of the physical FW device 51 and is a set of rules. FIG. 6 is a schematic diagram illustrating an example of definition information stored in the definition information storing unit 63. As illustrated in FIG. 6, in the definition information, a rule number, a transmission source, a transmission destination, a port number/protocol, and an action are included.

The transmission source specifies a transmission source of a packet that is processed by the physical FW device 51. The transmission destination specifies a transmission destination of a packet that is processed by the physical FW device 51. The port number specifies a port number of a packet that is processed by the physical FW device 51. The protocol specifies a protocol of a packet processed by the physical FW device 51. The action specifies an operation performed by the physical FW device 51 and is permission, blocking, or the like.

For example, permission of sending a TCP packet from an “interface A” to a port “80” of a “server A” is specified by the rule “234”. Here, the “interface A” is the name of an interface of the physical FW device 51, the “server A” is the name of the VM host 4, the “tcp” indicates a TCP, and the “accept” indicates permission. The number of definitions in FIG. 6 is four.

The FW processing unit 71 performs, for example, permission or blocking of a packet on the basis of the definition information, stores the log information, and updates the statistical information. The packet processing unit 72 delivers a received packet to the FW processing unit 71 and sends the packet on the basis of the instruction received from the FW processing unit 71. The request processing unit 73 receives an instruction from the cloud management device 2, updates the definition information, or sends the log information or the statistical information to the cloud management device 2 on the basis of the instruction.

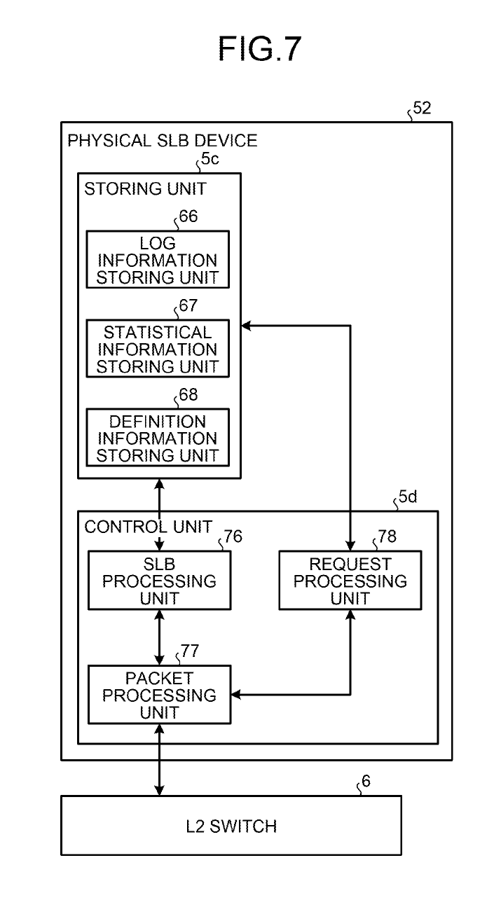

In the following, the configuration of the physical SLB device 52 will be described. FIG. 7 is a schematic diagram illustrating the configuration of the physical SLB device 52. As illustrated in FIG. 7, the physical SLB device 52 includes a storing unit 5c and a control unit 5d. The storing unit 5c is a storage device that stores therein information and includes a log information storing unit 66, a statistical information storing unit 67, and a definition information storing unit 68. The control unit 5d is a control device that controls the physical SLB device 52 by using the information stored in the storing unit 5c and includes an SLB processing unit 76, a packet processing unit 77, and a request processing unit 78.

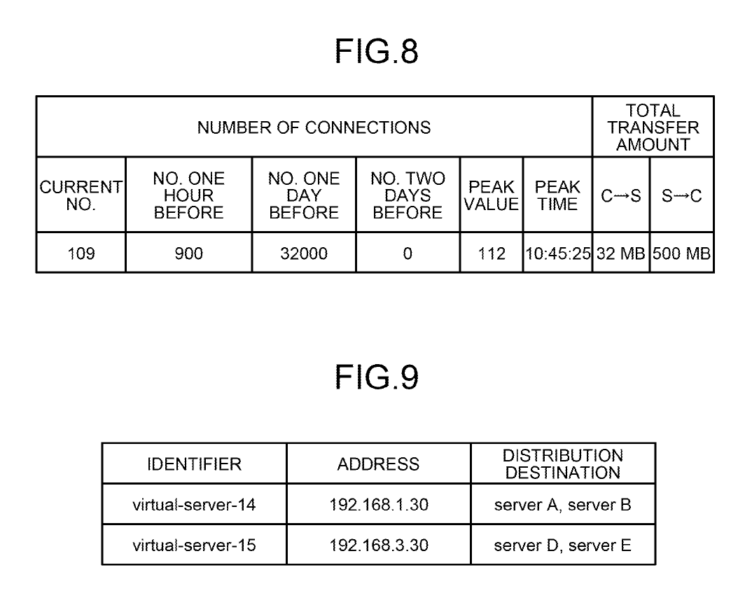

The log information storing unit 66 stores therein log information on the physical SLB device 52. The statistical information storing unit 67 stores therein statistical information on the physical SLB device 52. FIG. 8 is a schematic diagram illustrating an example of the statistical information stored in the statistical information storing unit 67. As illustrated in FIG. 8, in the statistical information, the number of connections and a total transfer amount are included. In the number of connections, current No., No. one hour before, No. one day before, No. two days before, a peak value, and the peak time are included. In the total transfer amount, C→S and S→C are included.

The current No. is the number of current connections and the No. one hour before is the number of connections one hour before. The No. one day before is the number of connections one day before and the No. two days before is the number of connections two days before. The peak value is the number of connections per one second at the peak time and the peak time is the time at the peak time. The symbol of C→S indicates an amount of packet transferred from the outside to the cloud system 1 and the symbol of S→C indicates an amount of packet transferred from the cloud system 1 to the outside.

In FIG. 8, the number of connections is currently “109”, was “900” one hour before, was “32000” one day before, and was “0” two days before. Furthermore, the peak value is “112” and the time at the peak time is “10:45:25”. Furthermore, for a total transfer amount, the amount of the packet transferred from the outside to the cloud system 1 is 32 MB (megabytes) and the amount of the packet transferred from the cloud system 1 to the outside is 500 MB.

The definition information storing unit 68 stores therein definition information on the physical SLB device 52. The definition information mentioned here is information that is used to define an operation of the physical SLB device 52 and specifies the destination of the load balancing. FIG. 9 is a schematic diagram illustrating an example of definition information stored in the definition information storing unit 68. As illustrated in FIG. 9, in the definition information, an identifier, an address, and a distribution destination are included. The identifier is information for identifying each definition. The address is the IP address of the transmission destination of a packet. The distribution destination indicates the VM host 4 at the transfer destination of the packet that was sent to the IP address.

For example, the packet with the destination IP address of “192.168.1.30” is transferred to the “server A” or the “server B”. Here, “server A” and the “server B” is the name of each of the VM hosts 4. The number of definitions in FIG. 9 is two.

The SLB processing unit 76 distributes loads on the basis of the definition information, stores the log information, and updates the statistical information. The packet processing unit 77 delivers a received packet to the SLB processing unit 76 and sends the packet on the basis of an instruction received from the SLB processing unit 76. The request processing unit 78 receives an instruction from the cloud management device 2, updates the definition information or sends the log information or the statistical information to the cloud management device 2 on the basis of the instruction.

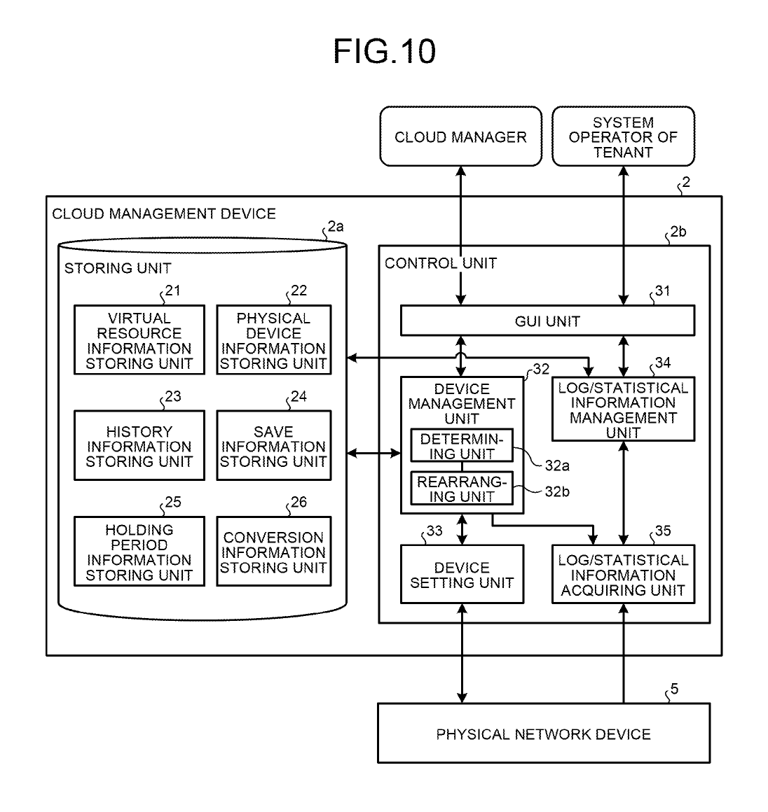

In the following, the configuration of the cloud management device 2 will be described. FIG. 10 is a schematic diagram illustrating the configuration of the cloud management device 2. As illustrated in FIG. 10, the cloud management device 2 includes a storing unit 2a and a control unit 2b. The storing unit 2a is a storage device that stores therein information and includes a virtual resource information storing unit 21, a physical device information storing unit 22, a history information storing unit 23, a save information storing unit 24, a holding period information storing unit 25, and a conversion information storing unit 26. The control unit 2b is a control device that controls the cloud management device 2 by using the information stored in the storing unit 2a and includes a graphical user interface (GUI) unit 31, a device management unit 32, a device setting unit 33, a log/statistical information management unit 34, and a log/statistical information acquiring unit 35.

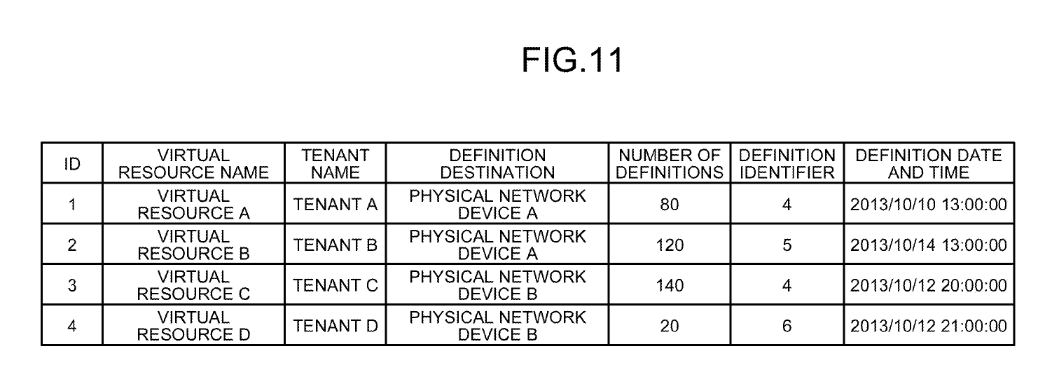

The virtual resource information storing unit 21 stores therein information that is used to define the virtual resources 8 as virtual resource information. FIG. 11 is a schematic diagram illustrating an example of virtual resource information stored in the virtual resource information storing unit 21. As illustrated in FIG. 11, in the virtual resource information, an ID, a virtual resource name, a tenant name, a definition destination, the number of definitions, a definition identifier, and the definition date and time are included.

The ID is an identification number that is used to identify the virtual resource 8. The virtual resource name is the name of the virtual resource 8. The tenant name is the name of tenant to which the virtual resource 8 is allocated. The definition destination is the name of the physical network device 5 in which the virtual resource 8 is arranged. The number of definitions is the number of definitions that are used by the virtual resource 8. The definition identifier is the number that is used to identify the virtual resource 8 in the physical network device 5 in which the virtual resource 8 is arranged. The definition date and time is the date and time at which the virtual resource 8 is defined.

For example, for the virtual resource 8 with the identification number of “1”, the name thereof is the “virtual resource A”, the name of the allocated tenant is the “tenant A”, the destination of arrangement is the physical network device 5 with the name of the “physical network device A”, and the amount of the resource is “80”. Furthermore, this virtual resource 8 is identified by “4” in the “physical network device A” and is defined at “13:00:00 on 2013/10/10”.

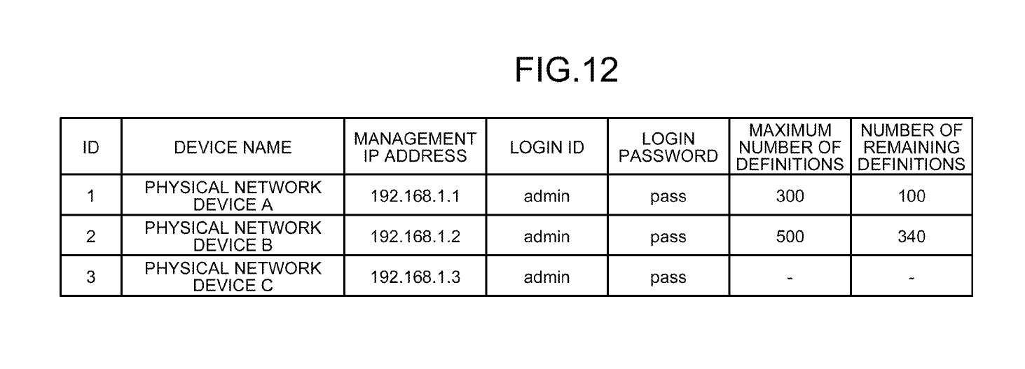

The physical device information storing unit 22 stores therein the information about the physical network devices 5 as physical device information. FIG. 12 is a schematic diagram illustrating an example of physical device information stored in the physical device information storing unit 22. As illustrated in FIG. 12, in the physical device information, an ID, an device name, a management IP address, a login ID, a login password, the maximum number of definitions, and the number of remaining definitions are included.

The ID is an identification number that is used to identify the physical network device 5. The device name is a name of the physical network device 5. The management IP address is the IP address of the physical network device 5. The login ID is the identifier that is used at the time of login to the physical network device 5 and the login password is the password that is used at the time of login. The maximum number of definitions is the maximum number of definitions that can be set in the physical network device 5 and the number of remaining definitions is the number of definitions that can be set in the future.

For example, for the physical network device 5 with the identification number of “1”, the name thereof is the “physical network device A”, the IP address is “192.168.1.1”, the identifier that is used at the time of login is “admin”, and the login password is “pass”. Furthermore, for the physical network device 5, the number of definitions that can be set is up to the maximum of “300” and the number of definitions that can be set in the future is “100”.

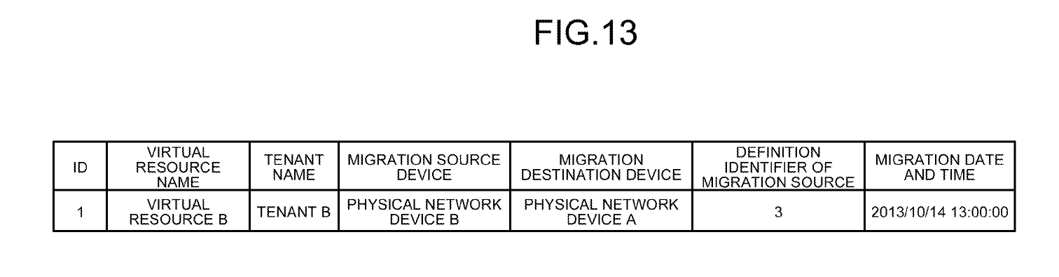

The history information storing unit 23 stores therein the history information about migration of the virtual resource 8. FIG. 13 is a schematic diagram illustrating an example of history information stored in the history information storing unit 23. As illustrated in FIG. 13, in the history information, an ID, a virtual resource name, a tenant name, a migration source device, a migration destination device, a definition identifier of the migration source, and migration date and time are included.

The ID is an identification number that is used to identify migration. The virtual resource name is the name of the migrated virtual resource 8. The tenant name is the name of the tenant to which the migrated virtual resource 8 is allocated. The migration source device is the name of the physical network device 5 of the migration source. The migration destination device is the name of the physical network device 5 of the migration destination. The definition identifier of the migration source is the identifier that is used to identify the migrated virtual resource 8 in the physical network device 5 of the migration source. The migration date and time is the date and time at which the migration is performed.

For example, the “virtual resource B” allocated to the “tenant B” is migrated from the “physical network device B” to the “physical network device A” at “13:00:00 on 2013/10/14” and the “virtual resource B” is identified by “3” as the migration source.

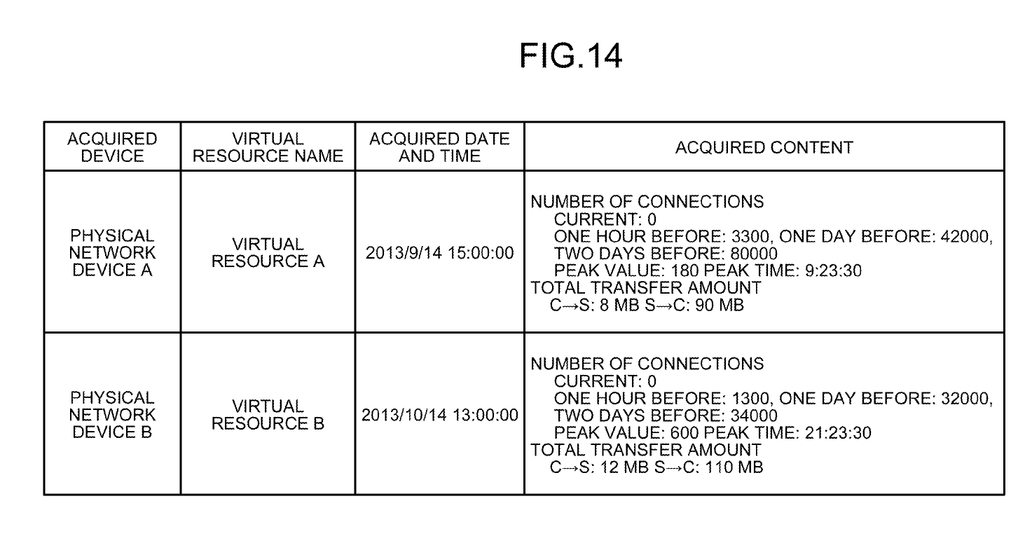

The save information storing unit 24 stores therein, as save information, the statistical information that is stored by the physical network device 5 of the migration source when the migration of the virtual resources 8 is performed. FIG. 14 is a schematic diagram illustrating an example of save information stored in the save information storing unit 24. As illustrated in FIG. 14, in the save information, an acquired device, a virtual resource name, acquired date and time, and acquired content are included.

The acquired device is the physical network device 5 of the migration source in which the statistical information is acquired when the virtual resource 8 has been migrated. The virtual resource name is the name of the virtual resource 8 in which the statistical information is acquired. The acquired date and time is the date and time at which the statistical information was acquired. The acquired content is the content of the acquired statistical information.

For example, the statistical information on the “virtual resource A” was acquired from the “physical network device A” at “15:00:00 on 2013/9/14” and the acquired statistical information is saved.

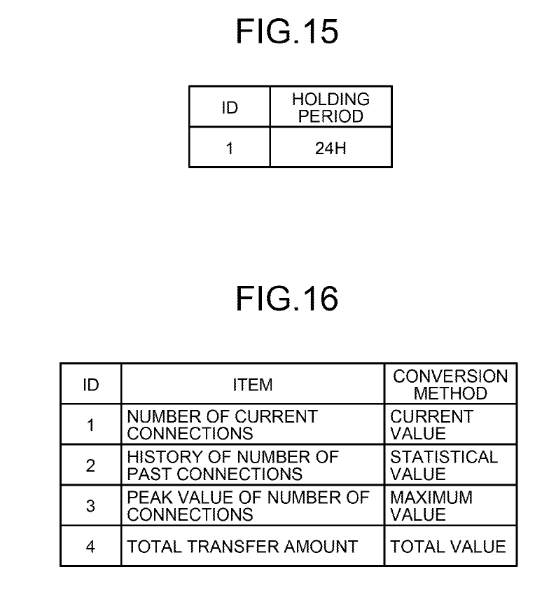

The holding period information storing unit 25 stores therein, as the holding period information, the time period for which the acquired statistical information is held. FIG. 15 is a schematic diagram illustrating an example of holding period information stored in the holding period information storing unit 25. As illustrated in FIG. 15, in the holding period information, an ID and a holding period are included. The ID is an identification number for identifying the holding period. The holding period is the time period for which the acquired statistical information is held. In FIG. 15, the holding period of the identification number of “1” is “24H”.

For a migrated virtual resource 8, the conversion information storing unit 26 stores therein, as conversion information, a method of converting the statistical information about before and after the migration to the statistical information that is provided to a cloud user. FIG. 16 is a schematic diagram illustrating an example of conversion information stored in the conversion information storing unit 26. As illustrated in FIG. 16, in the conversion information, an ID, an item, and a conversion method are included.

The ID is the identification number that is used to identify the conversion. The item is the conversion target in the statistical information. The conversion method is a method of conversion. For the conversion method, a “current value”, a “statistical value”, a “maximum value”, and a “total value” are present.

The “current value” indicates a method of acquiring, as a converted value, a value of the physical network device 5 after the migration. The “statistical value” uses, as a converted value, a value of the physical network device 5 arranged at the time of display; however, if migration is performed within the time period for which statistics are taken, the “statistical value” indicates a method of acquiring, as a converted value, a total value of the value before migration and the value after the migration.

The “maximum value” indicates a method of acquiring, as a converted value, a greater value by comparing the value before migration with the value after the migration. The “total value” indicates a method of acquiring, as a converted value, a total value of the value before migration and the value after the migration. An example of the conversion will be described later.

A description will be given here by referring back to FIG. 10. The GUI unit 31 that interacts with a cloud administrator and a system operator of each tenant and instructs the device management unit 32 and the log/statistical information management unit 34 on the basis of a request received from the cloud administrator and the system operator of each tenant.

The device management unit 32 manages the physical network devices 5 and the virtual resources 8 by using the virtual resource information storing unit 21, the physical device information storing unit 22, the history information storing unit 23, and the save information storing unit 24. When the device management unit 32 receives a request for adding to the virtual resource 8 from the system operator of the tenant, the device management unit 32 outputs an instruction needed for the device setting unit 33 and performs a process needed for adding to the virtual resource 8.

The device management unit 32 includes a determining unit 32a and a rearranging unit 32b. By using the virtual resource information storing unit 21 and the physical device information storing unit 22, the determining unit 32a determines whether the definition of the virtual resource 8 can be added to the physical network device 5 in which the virtual resource 8 is arranged. If the definition of the virtual resource 8 is not able to be added to the physical network device 5 in which the virtual resource 8 is arranged, the rearranging unit 32b rearranges the virtual resource 8. If the definition of the virtual resource 8 is not able to be added even if the rearrangement is performed, the device management unit 32 requests the cloud administrator to increase the number of the physical network devices 5.

Furthermore, if the device management unit 32 migrates the virtual resource 8, the device management unit 32 stores the information about the migration in the history information storing unit 23, acquires the statistical information about the migrated virtual resource 8 from the physical network device 5 of the migration source, and stores the acquired information in the save information storing unit 24. Furthermore, the device management unit 32 updates the virtual resource information storing unit 21 and the physical device information storing unit 22 on the basis of the adding result about the virtual resource 8.

The device setting unit 33 instructs, on the basis of an instruction from the device management unit 32, the setting of the physical network device 5 and acquires the information from the physical network device 5. For example, on the basis of the instruction from the device management unit 32, the device setting unit 33 instructs the physical network device 5 to increase and delete the setting. Furthermore, on the basis of the instruction from the device management unit 32, the device setting unit 33 acquires the information about the number of remaining definitions from the physical network device 5.

The log/statistical information management unit 34 instructs the log/statistical information acquiring unit 35 to acquire the log information and the statistical information from the physical network device 5 and manages the log information and the statistical information. Furthermore, on the basis of the instruction from the system operator of the tenant, the log/statistical information management unit 34 sends, to the operation terminal used by the system operator of the tenant, the log information and the statistical information on the virtual resource 8 allocated to the system operator of the tenant.

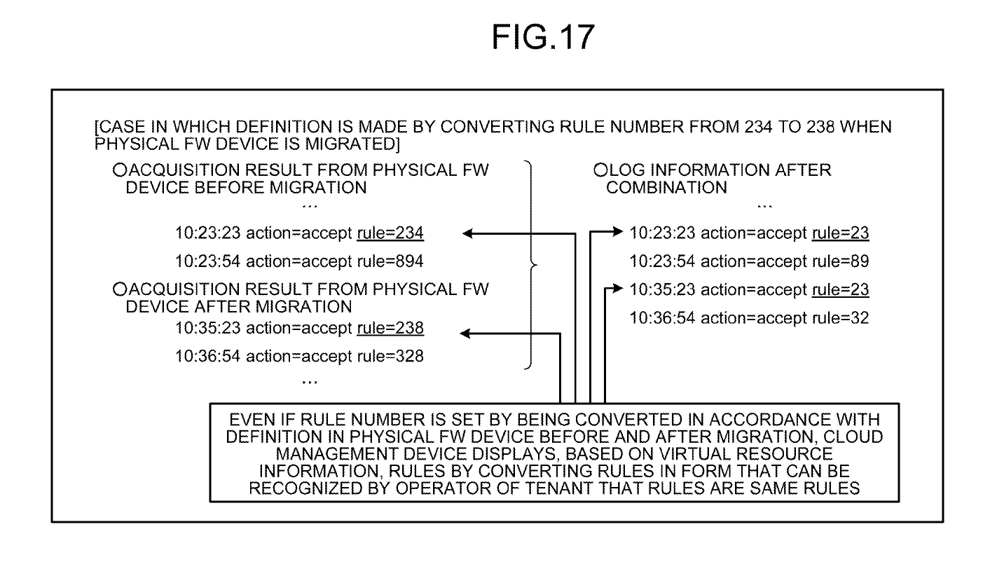

When the migration of the virtual resource 8 is performed, the log/statistical information management unit 34 combines the log information about before and after the migration and then sends the log information to the operation terminal that is used by the system operator of the tenant. FIG. 17 is a schematic diagram illustrating a combination of log information. FIG. 17 indicates a case in which a rule is defined by converting the rule number from 234 to 238 when migration is performed on the physical FW device 51 in which the virtual resource 8 is arranged.

Here, the third digit of “4” and “8” of the rule numbers are definition identifiers for the virtual resources 8 illustrated in FIG. 11. The definition identifier is attached to the rule number of “23” in order to identify, in the physical network device 5, the virtual resource 8 in which a rule has been set. In the physical FW device 51 before the migration, “4” is attached to the rule number of “23” of the rule that is set in a virtual resource 8, whereas, in the physical FW device 51 after the migration, “8” is added to the same rule with the rule number of “23” that is set to the same virtual resource 8.

In FIG. 17, “10:23:23 action=accept rule=234” that is the result of acquiring a log from the physical FW device 51 before migration indicates that the packet defined by the rule set by the rule number of 234 was received at 10:23:23. Furthermore, “10:35:23 action=accept rule=238” that is the result of acquiring a log from the physical FW device 51 after the migration indicates that the packet defined by the rule set by the rule number of 238 was received at 10:35:23.

The log/statistical information management unit 34 displays these logs such that the system operator of the tenant recognizes that these logs are information about the same rules. Namely, as illustrated in FIG. 17, in the log information after the combination, the log/statistical information management unit 34 converts the rule numbers of “234” and “238” of these two logs to a common rule number of “23” by excluding the definition identifier and displays the log information. In this way, because the log/statistical information management unit 34 displays the log by excluding the definition identifier from the rule numbers that are used before and after the migration, the system operator of the tenant can be aware that the logs before and after the migration are based on the same rules.

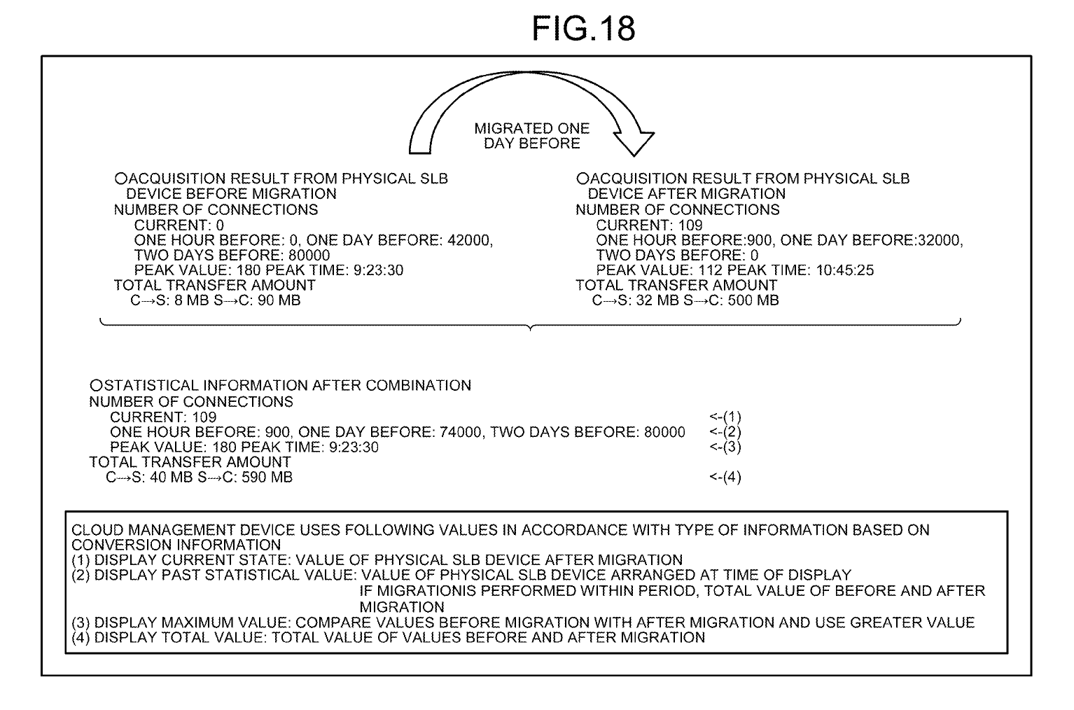

Furthermore, when the migration of the virtual resource 8 is performed, the log/statistical information management unit 34 combines, by using the conversion information storing unit 26, the statistical information before migration with the statistical information after the migration and sends the combined information to the operation terminal that is used by the system operator of the tenant. FIG. 18 is a schematic diagram illustrating a combination of statistical information. FIG. 18 indicates a case in which the physical SLB device 52 in which the virtual resource 8 targeted for a display of the statistical information is arranged is migrated a day before.

As illustrated in FIG. 18, regarding the statistical information acquired from the physical SLB device 52 before the migration, the number of connections is currently “0”, is “0” one hour before, is “42000” a day before, is “80000” two days before, and is “180” at the peak time. Furthermore, the peak time is “9:23:30”. Furthermore, for the total transfer amount, the amount of the packet transferred from the outside to the cloud system 1 is 8 MB and the amount of the packet transferred from the cloud system 1 to the outside is 90 MB.

Furthermore, regarding the statistical information acquired from the physical SLB device 52 after the migration, the number of connections is currently “109”, is “900” one hour before, is “32000” a day before, is “0” two days before, and “112” at the peak time. Furthermore, the peak time is “10:45:25”. Furthermore, for the total transfer amount, the amount of the packet transferred from the outside to the cloud system 1 is 32 MB and the amount of the packet transferred from the cloud system 1 to the outside is 500 MB.

When the log/statistical information management unit 34 combines the statistical information before the migration with the statistical information after the migration, the log/statistical information management unit 34 converts the information for each item on the basis of the conversion information illustrated in FIG. 16. Namely, for the number of the current connections, the log/statistical information management unit 34 sets the value of the physical SLB device 52 after the migration as a value after the combination (1). This conversion is associated with the “current value” illustrated in FIG. 16. In FIG. 18, for the number of the current connections, the value “109” of the physical SLB device 52 after the migration is set as the value after the statistical information was combined.

Furthermore, for the number of the past connections, the log/statistical information management unit 34 sets the value of the physical SLB device 52 in which the virtual SLB device 82 is arranged at the time of display, i.e., the past statistical value, as the value after the combination (2). However, if the virtual resource 8 is migrated within the period, the log/statistical information management unit 34 sets the total value of the value before the migration and the value after the migration. This conversion is associated with the “statistical value” illustrated in FIG. 16. In FIG. 18, the number of connections one hour before is the statistical value “900” after the migration. The number of connections a day before is, because the migration was performed a day before, the total value of before and after the migration, i.e., “42000”+“32000”=“74000”. The number of connections two days before is the statistical value “80000” before the migration.

Furthermore, for the peak value of the number of connections, the log/statistical information management unit 34 compares the value before and after the migration and sets the greater value as the value after the combination (3). This conversion is associated with the “maximum value” illustrated in FIG. 16. In FIG. 18, the value “180” that is obtained before the conversion and that has a greater peak value is set as the value after the combination.

Furthermore, for the total transfer amount, the log/statistical information management unit 34 sets the total value of the value before the migration and the value after the migration as the value after the combination (4). This conversion is associated with the “total value” illustrated in FIG. 16. In FIG. 18, C→S is the total value of before and after the migration, i.e., “8 MB”+“32 MB”=“40 MB”, and S→C is the total value of before and after the migration, i.e., “90 MB”+“500 MB”=“590 MB”.

The log/statistical information acquiring unit 35 acquires, on the basis of an instruction from the log/statistical information management unit 34, the log information and the statistical information from the physical network device 5 and delivers the information to the log/statistical information management unit 34. Furthermore, the log/statistical information acquiring unit 35 acquires, on the basis of an instruction from the device management unit 32, the statistical information from the physical network device 5 and delivers the information to the device management unit 32.

In the following, the flow of a process of adding to a virtual resource 8 will be described. Because an addition to a virtual resource 8 is an addition of a setting of the physical network device 5, the process of adding to a virtual resource 8 corresponds to the process of adding a setting.

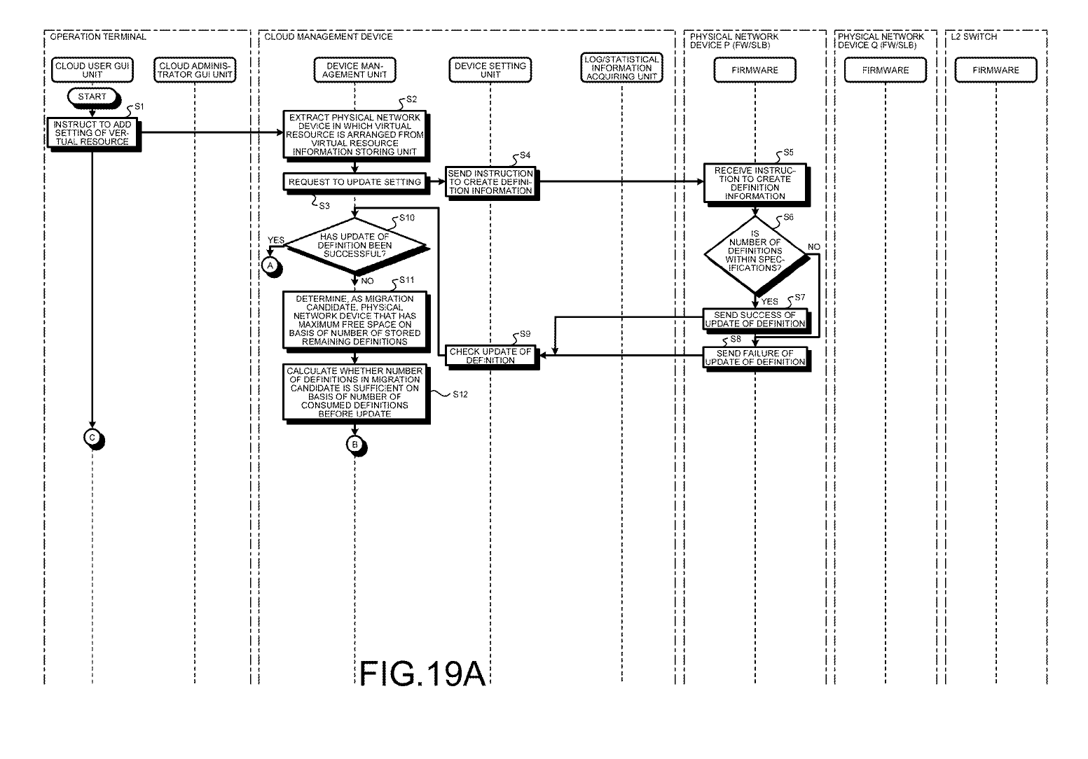

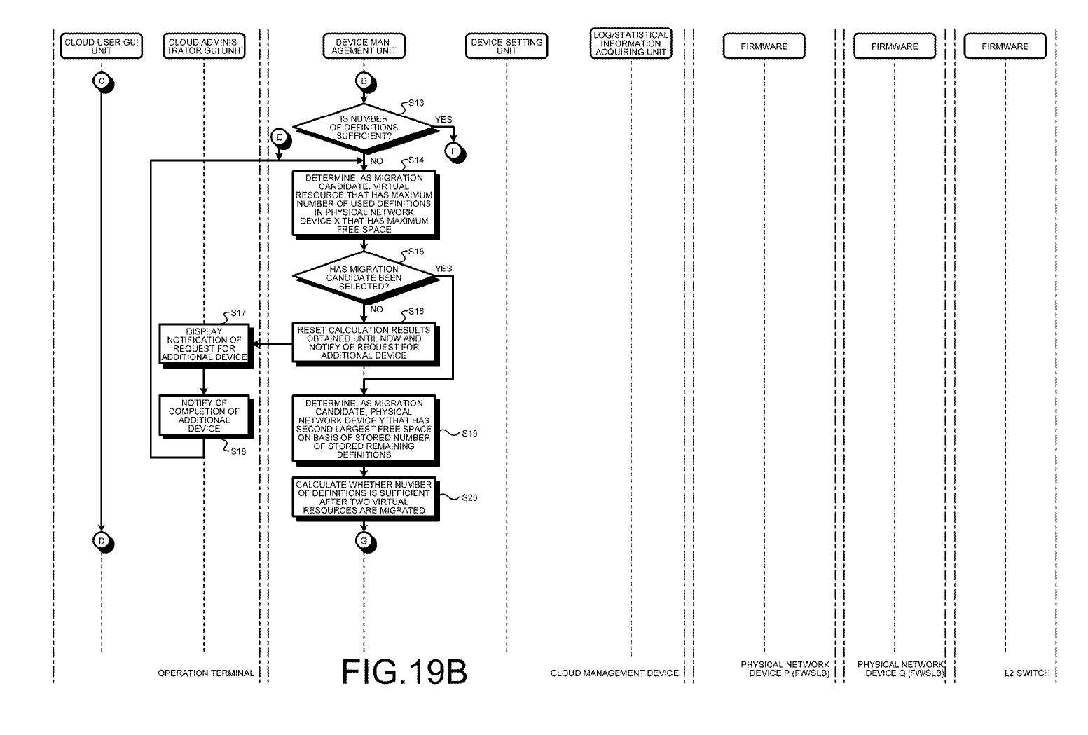

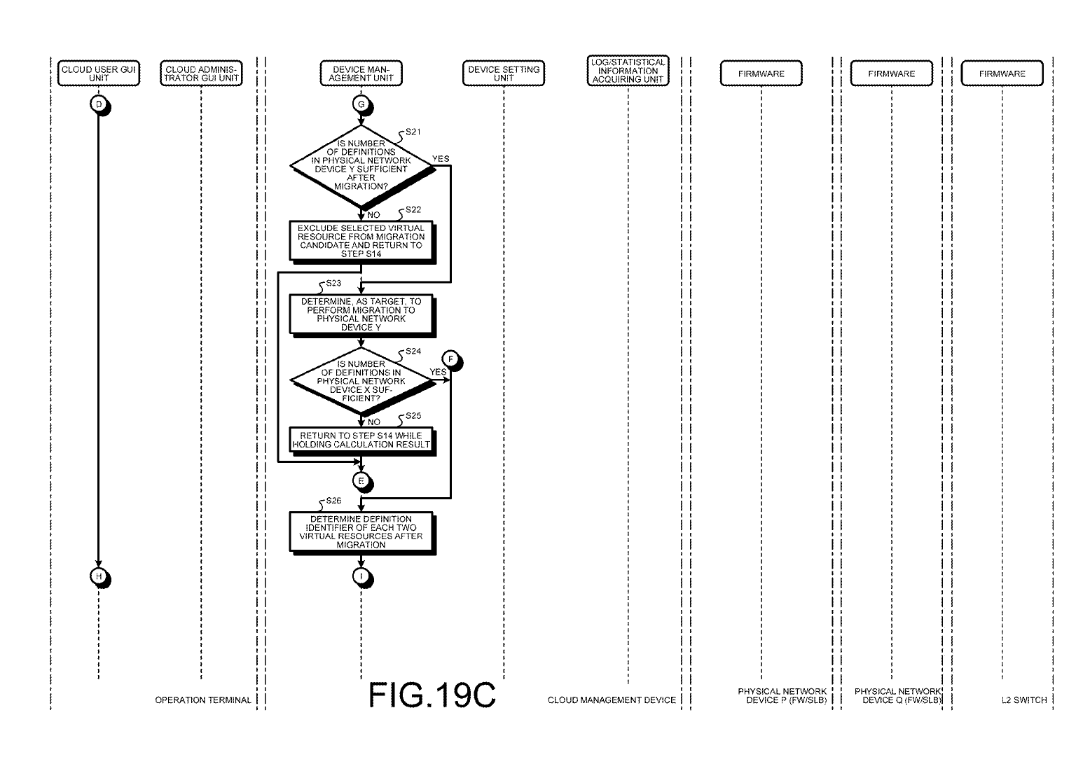

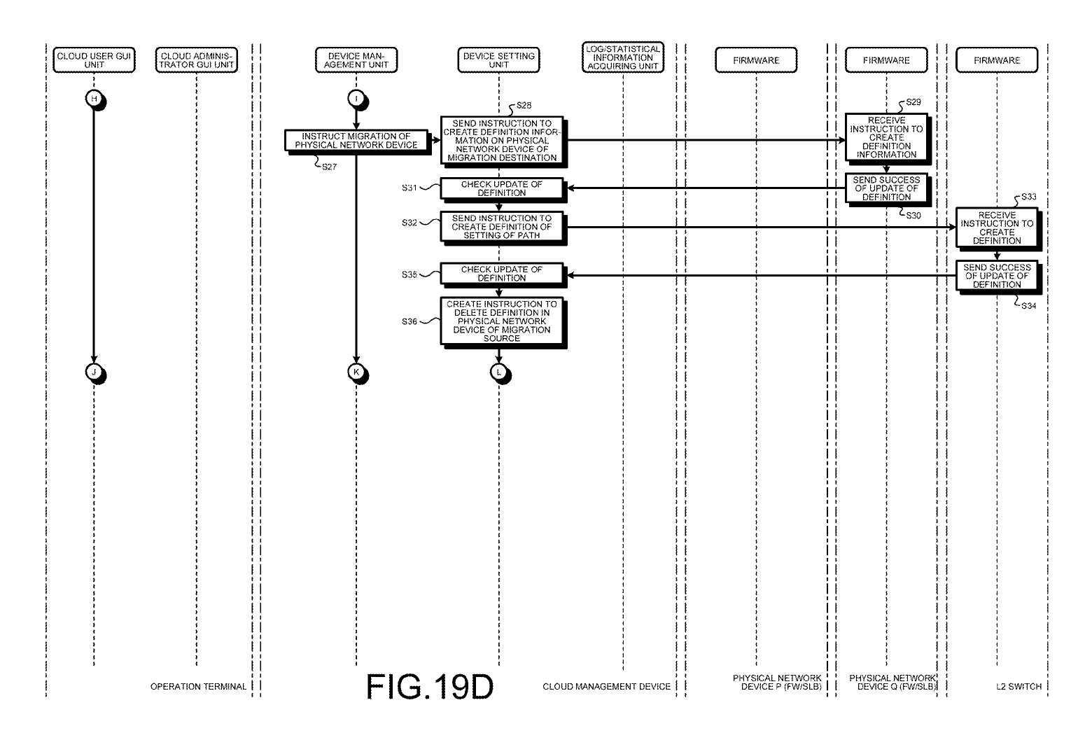

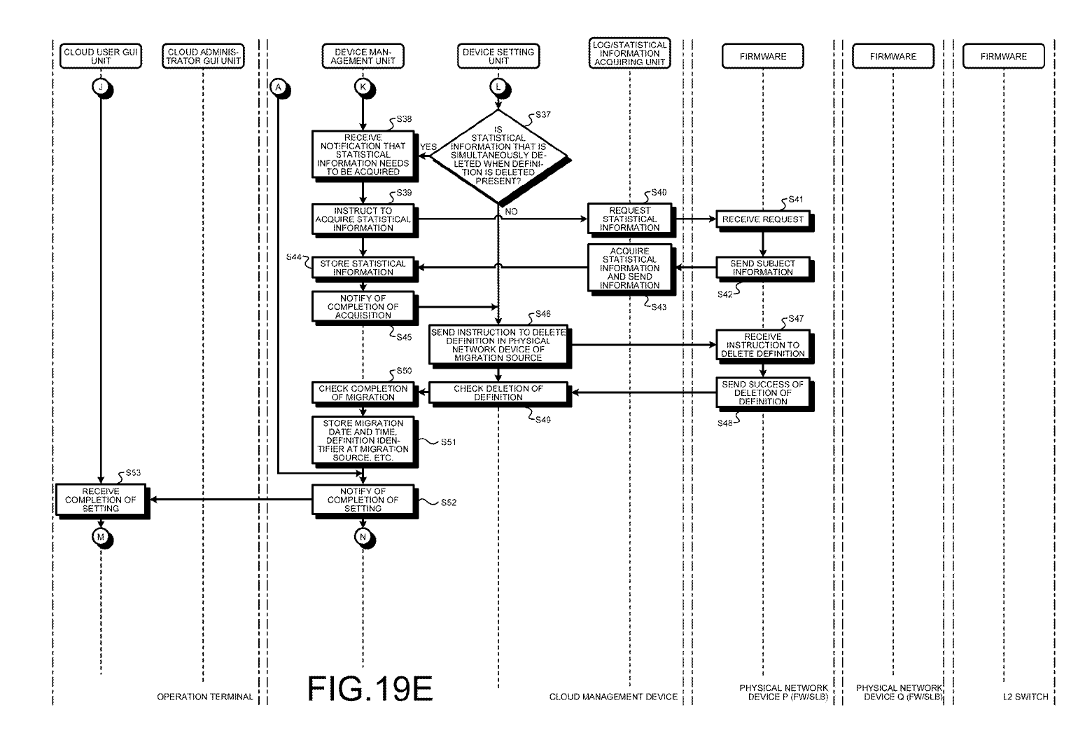

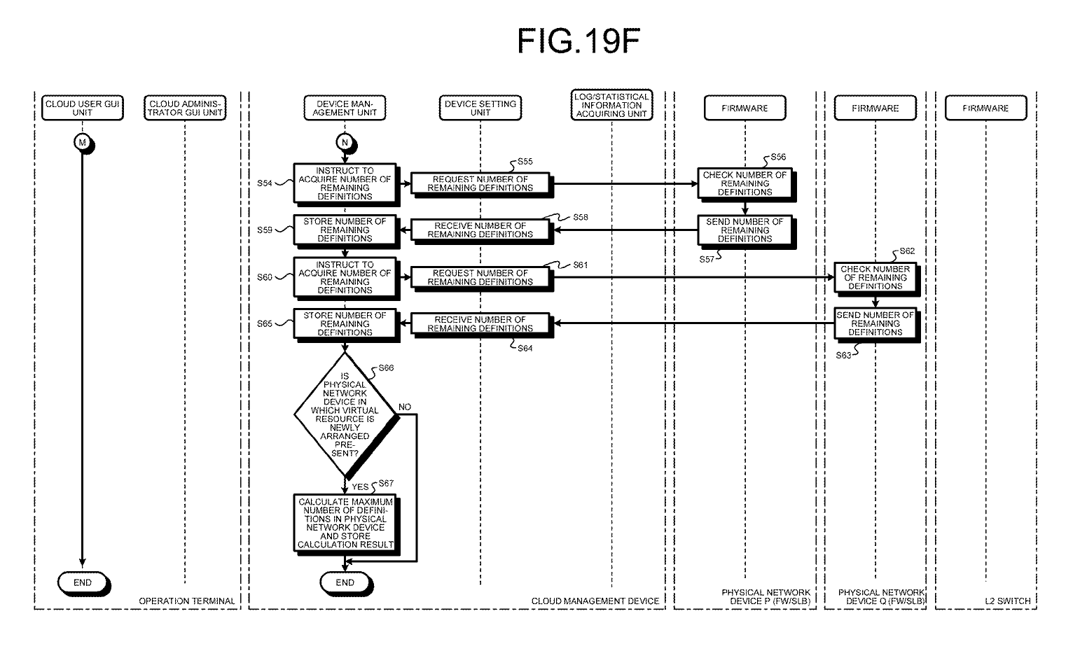

FIGS. 19A to 19F are flowcharts each illustrating the flow of a setting addition process. In the flowchart illustrated in FIG. 19A and the subsequent drawings, the cloud user GUI unit dialogs with a cloud user, sends an instruction from the cloud user to the cloud management device 2, and displays a response received from the cloud management device 2 on the operation terminal. Furthermore, the cloud administrator GUI unit dialogs with a cloud administrator, sends an instruction from the cloud administrator to the cloud management device 2, and displays a response received from the cloud management device 2 on the operation terminal. The cloud user GUI unit and the cloud administrator GUI unit are running on the operation terminal. Furthermore, physical network device P and physical network device Q are the physical network devices 5, the firmware is software executed by the physical network device 5 or the L2 switch 6.

As illustrated in FIG. 19A, the cloud user GUI unit instructs, on the basis of an instruction from the cloud user, the cloud management device 2 to add a setting of a virtual resource 8 (Step S1). Then, the device management unit 32 in the cloud management device 2 extracts the physical network device 5 in which the virtual resource 8 is arranged from the virtual resource information storing unit 21 (Step S2). Then, the device management unit 32 requests the device setting unit 33 to update the setting of the extracted physical network device 5 (Step S3).

Then, the device setting unit 33 sends, on the basis of the request from the device management unit 32, an instruction to create the definition information to the physical network device P (Step S4). Then, the physical network device P receives the instruction to create the definition information (Step S5) and determines whether the number of definitions to which the definition to be created on the basis of the instruction is added is within specifications (Step S6). The term of “within specifications” mentioned here is within the maximum number of definitions that can be set in the physical network device 5.

If the number of definitions is within the specifications, the physical network device P creates a definition, performs additional setting, and sends, to the cloud management device 2, a success of the update of the definition (Step S7). In contrast, if the number of definitions is not within the specifications, the physical network device P sends, to the cloud management device 2, a failure of the update of the definition (Step S8).

Then, the device setting unit 33 checks the update of the definition (Step S9) and determines whether the device management unit 32 has successfully updated the definition (Step S10). If the determination result indicates that the update has been successful, the device management unit 32 proceeds to Step S52.

In contrast, if the update has failed, the device management unit 32 determines a physical network device 5, as a migration candidate, that has the maximum free space on the basis of the number of remaining definitions stored in the physical device information storing unit 22 (Step S11) and calculates, on the basis of the number of consumed definitions before the update, whether the number of definitions in the migration candidate is sufficient (Step S12). Then, as illustrated in FIG. 19B, the device management unit 32 determines whether the number of definitions in the migration candidate is sufficient (Step S13) and, if the number of definitions is sufficient, the device management unit 32 proceeds to Step S26.

In contrast, if the number of definitions is insufficient, the device management unit 32 determines, as the migration candidate, a virtual resource 8 that has the maximum number of currently used definitions in the physical network device X that has the maximum free space, (Step S14) and determines whether the migration candidate has been selected (Step S15). If the determination result indicates that the migration candidate was not able to be selected, the device management unit 32 resets the calculation results obtained until now and notifies the operation terminal of a request for additional device (Step S16). Then, the cloud administrator GUI unit displays the notification of the request for the additional device (Step S17) and, if the cloud administrator GUI unit receives the completion of the additional device from the cloud administrator, the cloud administrator GUI unit notifies the cloud management device 2 of the completion of the additional device (Step S18). Then, the device management unit 32 returns to Step S14.

In contrast, if a migration candidate was able to be selected, the device management unit 32 determines, as a migration candidate, the physical network device Y that has the second largest free space on the basis of the number of remaining definitions stored in the physical device information storing unit 22 (Step S19). Then, the device management unit 32 calculates whether the number of definitions is sufficient after the two virtual resources 8 are migrated (Step S20). The two virtual resources 8 mentioned here indicate the virtual resource 8 determined as the migration candidate and the virtual resource 8 requested the additional setting.

Then, as illustrated in FIG. 19C, the device management unit 32 determines whether the number of definitions in the physical network device Y is sufficient after the migration (Step S21). If the number of definitions is insufficient, the device management unit 32 excludes the selected virtual resource 8 from the migration candidate and returns to Step S14 (Step S22). In contrast, if the number of definitions is sufficient, the device management unit 32 determines, as the target, to perform migration to the physical network device Y (Step S23) and determines whether the number of definitions in the physical network device X is sufficient (Step S24). If the determination result indicates that the number of definitions is insufficient, the device management unit 32 returns to Step S14 while holding the calculation result (Step S25).

In contrast, if the number of definitions is sufficient, the device management unit 32 determines a definition identifier for each of the two virtual resources 8 after the migration (Step S26) and performs the following processes at Steps S27 to S51 for each of the virtual resources 8 that are to be migrated.

Namely, as illustrated in FIG. 19D, for each of the virtual resources 8 to be migrated, the device management unit 32 instructs the device setting unit 33 about the migration in the physical network device 5 (Step S27). Then, the device setting unit 33 sends, to the physical network device Q, an instruction to create definition information on the physical network device 5 of the migration destination (Step S28). Here, the physical network device Q is assumed to be the physical network device 5 of the migration destination.

Then, the physical network device Q receives the instruction to create the definition information (Step S29), creates the definition information on the basis of the instruction, and performs the setting. Then, the physical network device Q sends, to the cloud management device 2, the information indicating that the update of the definition is successful (Step S30).

Then, the device setting unit 33 checks the update of the definition (Step S31) and sends, to the L2 switch 6, an instruction to create a definition of the setting of a path (Step S32). Then, the L2 switch 6 receives the instruction to create the definition (Step S33), creates definition information on the basis of the instruction, and performs the setting. Then, the L2 switch 6 sends, to the cloud management device 2, a success of the update of the definition (Step S34).

Then, the device setting unit 33 checks the update of the definition (Step S35) and creates an instruction to delete the definition in the physical network device 5 of the migration source (Step S36). Then, as illustrated in FIG. 19E, the device setting unit 33 determines whether the statistical information that is simultaneously deleted when the definition is deleted is present (Step S37). If the determination result indicates that no statistical information that is simultaneously deleted is present, the device setting unit 33 proceeds to Step S46.

In contrast, if the statistical information that is simultaneously deleted is present, the device setting unit 33 notifies the device management unit 32 that the statistical information needs to be acquired. Then, the device management unit 32 receives the notification that the statistical information needs to be acquired (Step S38) and instructs the log/statistical information acquiring unit 35 to acquire the statistical information (Step S39). Then, the log/statistical information acquiring unit 35 requests the statistical information from the physical network device P (Step S40). Here, the physical network device P is assumed to be the physical network device 5 of the migration source.

Then, the physical network device P receives the request for the statistical information (Step S41) and sends the subject information to the cloud management device 2 (Step S42). Then, the log/statistical information acquiring unit 35 acquires the statistical information and sends the information to the device management unit 32 (Step S43). Then, the device management unit 32 receives the statistical information and stores the statistical information (Step S44). Then, the device management unit 32 notifies the device setting unit 33 that the acquisition of the statistical information has been completed (Step S45).

Then, the device setting unit 33 sends, to the physical network device P, an instruction to delete the definition in the physical network device 5 of the migration source (Step S46). Then, the physical network device P receives the instruction to delete the definition (Step S47) and deletes the definition information on the basis of the instruction. Then, the physical network device P sends, to the cloud management device 2, a success of deletion of the definition (Step S48). Then, the device setting unit 33 checks the deletion of the definition (Step S49) and notifies the device management unit 32 of the completion of the migration. Then, the device management unit 32 checks the completion of the migration (Step S50) and stores, as history information, the migration date and time, the definition identifier at the migration source, or the like (Step S51).

Then, the device management unit 32 notifies the operation terminal of the completion of the setting (Step S52) and the cloud user GUI unit receives the completion of the setting (Step S53) and displays the completion of the setting on the display device.

Furthermore, as illustrated in FIG. 19F, the device management unit 32 instructs the device setting unit 33 to acquire the number of remaining definitions in the physical network device P (Step S54) and the device setting unit 33 requests the number of remaining definitions from the physical network device P (Step S55). Then, the physical network device P checks the number of remaining definitions (Step S56) and sends the checked number of the remaining definitions to the cloud management device 2 (Step S57). Then, the device setting unit 33 receives the number of the remaining definitions (Step S58) and the device management unit 32 stores the number of the remaining definitions in the physical device information storing unit 22 (Step S59).

Then, the device management unit 32 instructs the device setting unit 33 to acquire the number of the remaining definitions in the physical network device Q (Step S60) and the device setting unit 33 requests the number of the remaining definitions from the physical network device Q (Step S61). Then, the physical network device Q checks the number of the remaining definitions (Step S62) and sends the checked number of the remaining definitions to the cloud management device 2 (Step S63). Then, the device setting unit 33 receives the number of the remaining definitions (Step S64) and the device management unit 32 stores the number of the remaining definitions in the physical device information storing unit 22 (Step S65).

Then, the device management unit 32 determines whether the physical network device 5 in which the virtual resource 8 is newly arranged is present (Step S66). If the subject device is present, the device management unit 32 calculates the maximum number of definitions in the subject physical network device 5 and stores the calculation result in the physical device information storing unit 22 (Step S67).

As described above, if additional setting of the virtual resource 8 is not able to be performed on the physical network device 5 in which the virtual resource 8 is arranged, the device management unit 32 rearranges the virtual resource 8 to another physical network device, whereby a cloud administrator's work is not needed and it is possible to eliminate suspension of the use of the system by the tenant.

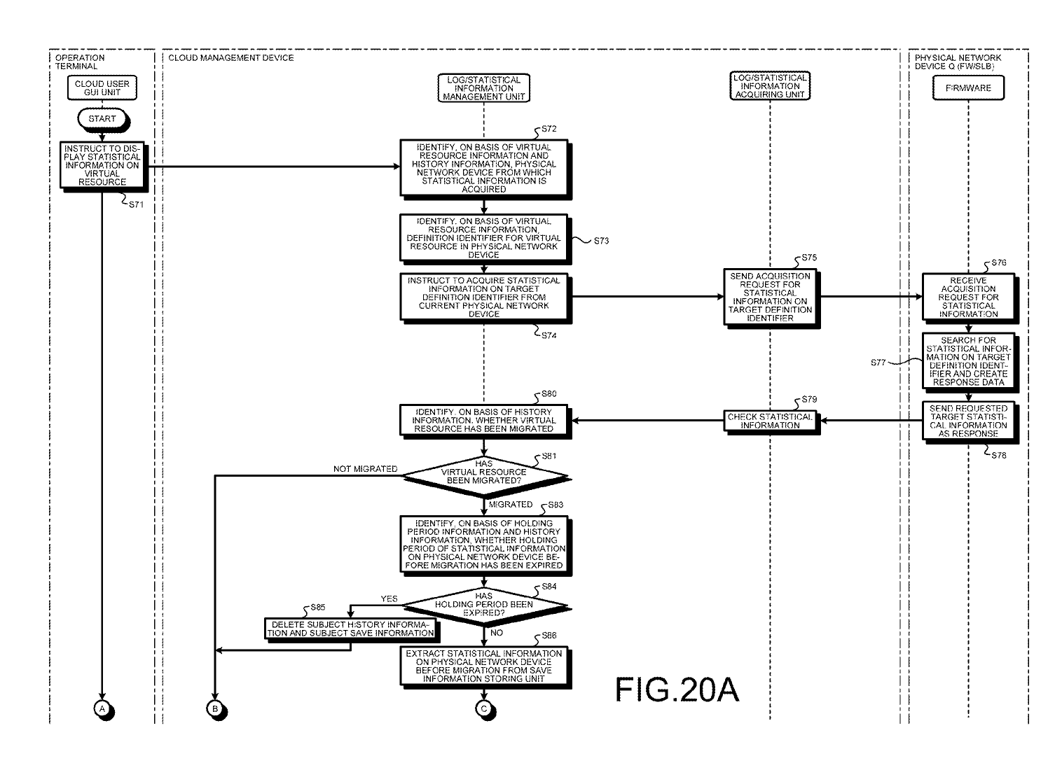

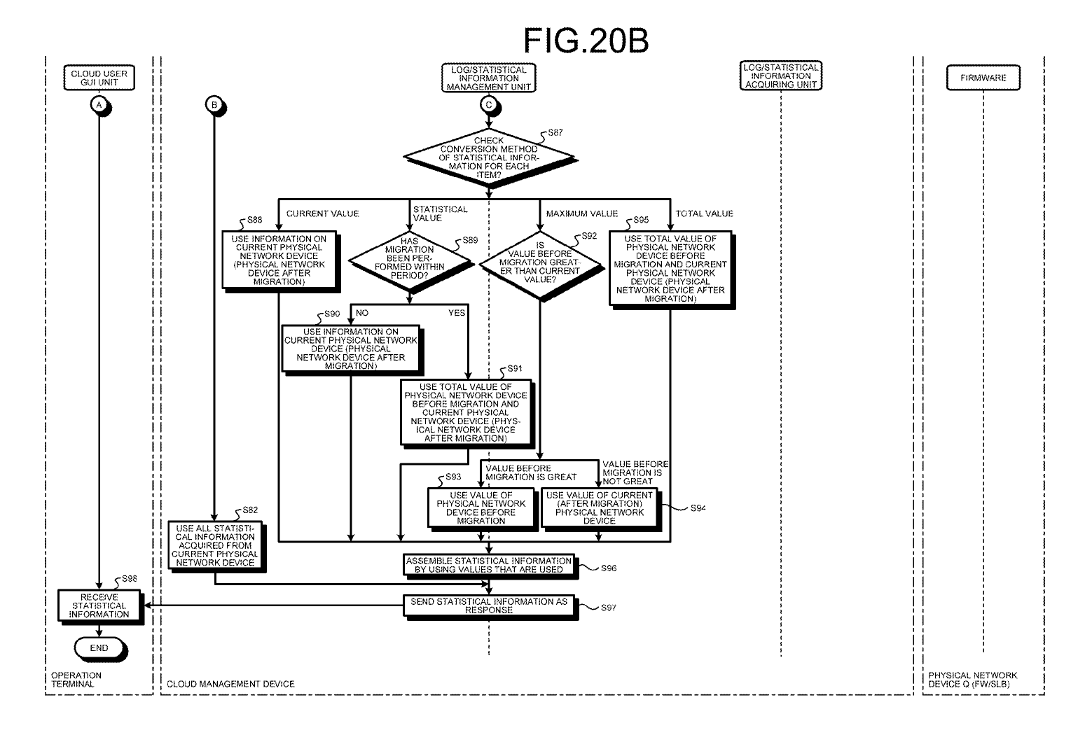

In the following, the flow of the statistical information acquiring process will be described. FIGS. 20A and 20B are flowcharts each illustrating the flow of a statistical information acquiring process. As illustrated in FIG. 20A, the cloud user GUI unit in the operation terminal instructs the cloud management device 2 to display the statistical information on a virtual resource 8 on the basis of the instruction from the cloud user (Step S71).

Then, the log/statistical information management unit 34 in the cloud management device 2 identifies, on the basis of the virtual resource information and the history information, a physical network device 5 from which the statistical information is acquired (Step S72). Then, the log/statistical information management unit 34 identifies, on the basis of the virtual resource information, the definition identifier for the virtual resource 8 in the physical network device 5 (Step S73). Then, the log/statistical information management unit 34 instructs the log/statistical information acquiring unit 35 to acquire the statistical information on the target definition identifier from the current physical network device 5 (Step S74).

Then, the log/statistical information acquiring unit 35 sends the acquisition request for the statistical information on the target definition identifier to the physical network device Q (Step S75). Here, the physical network device Q is the physical network device 5 in which the virtual resource 8 is currently arranged. Then, the physical network device Q receives the acquisition request for the statistical information (Step S76), searches for the statistical information on the target definition identifier, and creates response data (Step S77). Then, the physical network device Q sends, to the cloud management device 2, the requested target statistical information as a response (Step S78).

Then, the log/statistical information acquiring unit 35 checks the statistical information (Step S79) and sends the statistical information to the log/statistical information management unit 34. Then, the log/statistical information management unit 34 receives the statistical information. Then, the log/statistical information management unit 34 identifies, on the basis of the history information, whether the virtual resource 8 has been migrated (Step S80) and determines whether the virtual resource 8 has been migrated (Step S81). If the determination result indicates that the migration has not been performed, as illustrated in FIG. 20B, the log/statistical information management unit 34 uses all the statistical information acquired from the current physical network device 5 (Step S82) and proceeds to Step S97.

In contrast, if the migration has been performed, the log/statistical information management unit 34 identifies, on the basis of the holding period information and the history information, whether the holding period of the statistical information on the physical network device 5 before the migration has been expired (Step S83) and determines whether the holding period has been expired (Step S84). If the determination result indicates that the holding period has been expired, the log/statistical information management unit 34 deletes the subject history information and the subject save information (Step S85) and proceeds to Step S82.

In contrast, if the holding period has not been expired, the log/statistical information management unit 34 extracts the statistical information on the physical network device 5 before the migration from the save information storing unit 24 (Step S86) and checks, as illustrated in FIG. 20B, the conversion method of the statistical information for each item (Step S87).

Then, if the conversion method is “current value”, the log/statistical information management unit 34 uses the information on the current physical network device 5, i.e., the physical network device 5 after the migration, (Step S88) and then proceeds to Step S96.

If the conversion method is “statistical value”, the log/statistical information management unit 34 determines whether migration has been performed within the period (Step S89). If the migration has not been performed, the log/statistical information management unit 34 uses the information on the current physical network device 5, i.e., the physical network device 5 after the migration (Step S90), and then proceeds to Step S96. In contrast, if the migration is performed, the log/statistical information management unit 34 uses the total value of the physical network device 5 before the migration and the current physical network device 5 (Step S91) and then proceeds to Step S96.

If the conversion method is “maximum value”, the log/statistical information management unit 34 determines whether the value before the migration is greater than the current value (Step S92). If the value before the migration is greater, the log/statistical information management unit 34 uses the value of the physical network device 5 before the migration (Step S93) and proceeds to Step S96. In contrast, if the value before the migration is not greater, the log/statistical information management unit 34 uses the value of the current physical network device 5 (Step S94) and proceeds to Step S96.

If the conversion method is “total value”, the log/statistical information management unit 34 uses the total value of the physical network device 5 before the migration and the current physical network device 5 (Step S95) and proceeds to Step S96.

Then, the log/statistical information management unit 34 assembles the statistical information by using the values that are used (Step S96) and sends, to the operation terminal, the statistical information as a response (Step S97). Then, the cloud user GUI unit receives the statistical information (Step S98) and displays the information on the display device.

As described above, when the migration of the virtual resource 8 is performed, the log/statistical information management unit 34 creates the statistical information on the basis of the information about before and after the migration, the holding period, and the conversion method; therefore, the log/statistical information management unit 34 sends appropriate statistical information as a response to the operation terminal.

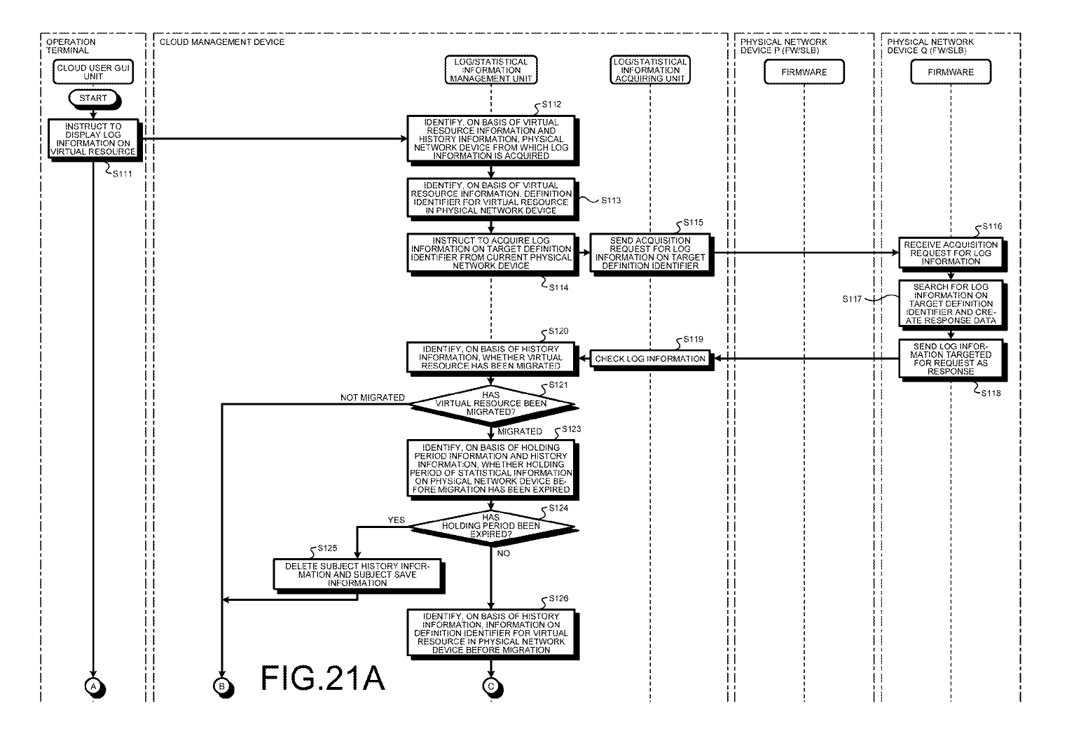

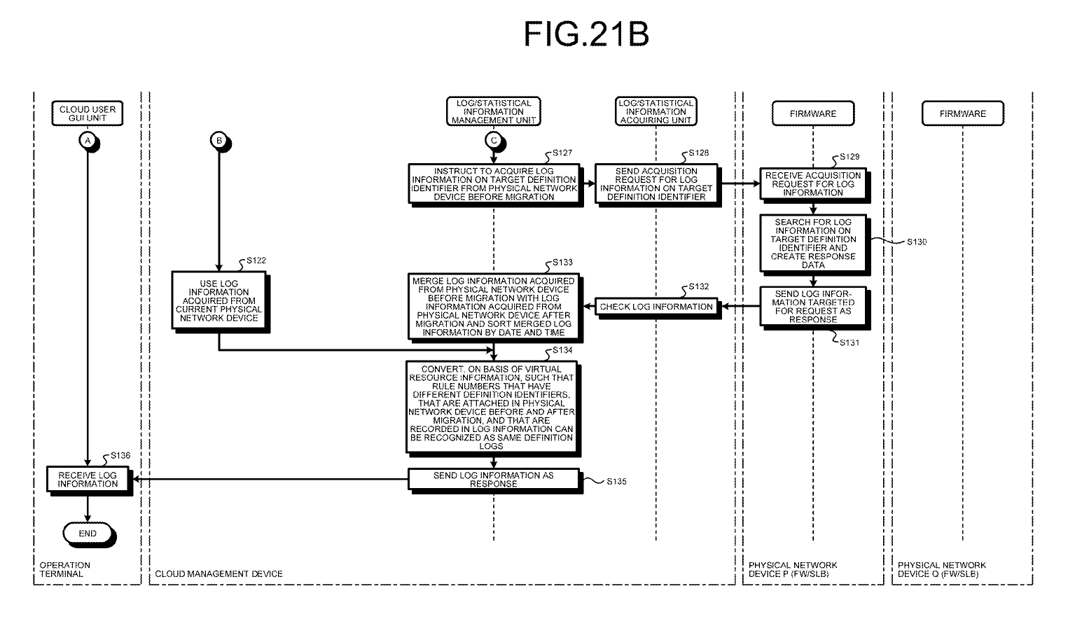

In the following, the flow of the log information acquiring process will be described. FIGS. 21A and 21B are flowcharts each illustrating the flow of the log information acquiring process. As illustrated in FIG. 21A, the cloud user GUI unit in the operation terminal instructs the cloud management device 2 to display the log information on a virtual resource 8 on the basis of the instruction from the cloud user (Step S111).

Then, the log/statistical information management unit 34 in the cloud management device 2 identifies, on the basis of the virtual resource information and the history information, the physical network device 5 from which the log information is acquired (Step S112). Then, the log/statistical information management unit 34 identifies, on the basis of the virtual resource information, the definition identifier for the virtual resource 8 in the physical network device 5 (Step S113). Then, the log/statistical information management unit 34 instructs the log/statistical information acquiring unit 35 to acquire the log information on the target definition identifier from the current physical network device 5 (Step S114).

Then, the log/statistical information acquiring unit 35 sends an acquisition request for the log information on the target definition identifier to the physical network device Q (Step S115). Here, the physical network device Q is the physical network device 5 in which the virtual resource 8 is currently arranged. Then, the physical network device Q receives the acquisition request for the log information (Step S116), searches for the log information on the target definition identifier, and creates response data (Step S117). Then, the physical network device Q sends the log information targeted for the request to the cloud management device 2 as a response (Step S118).

Then, the log/statistical information acquiring unit 35 checks the log information (Step S119) and sends the log information to the log/statistical information management unit 34. Then, the log/statistical information management unit 34 receives the log information. Then, the log/statistical information management unit 34 identifies, on the basis of the history information, whether the virtual resource 8 has been migrated (Step S120) and determines whether the virtual resource 8 has been migrated (Step S121). If the determination result indicates that the migration was not performed, the log/statistical information management unit 34 uses, as illustrated in FIG. 21B, the log information acquired from the current physical network device 5 (Step S122) and proceeds to Step S134.

In contrast, if the migration was performed, the log/statistical information management unit 34 identifies, on the basis of the holding period information and the history information, whether the holding period of the statistical information on the physical network device 5 before the migration has been expired (Step S123) and determines whether the holding period has been expired (Step S124). If the determination result indicates that the holding period has been expired, the log/statistical information management unit 34 deletes the subject history information and the subject save information (Step S125) and proceeds to Step S122.

In contrast, if the holding period has not been expired, the log/statistical information management unit 34 identifies, on the basis of the history information, the information on the definition identifier for the virtual resource 8 in the physical network device 5 before the migration (Step S126). Then, as illustrated in FIG. 21B, the log/statistical information management unit 34 instructs the log/statistical information acquiring unit 35 to acquire the log information on the target definition identifier from the physical network device 5 before the migration (Step S127).

Then, the log/statistical information acquiring unit 35 sends an acquisition request for the log information on the target definition identifier to the physical network device P (Step S128). Here, the physical network device P is the physical network device 5 in which the virtual resource 8 is arranged before the migration. Then, the physical network device P receives the acquisition request for the log information (Step S129), searches for the log information on the target definition identifier, and creates response data (Step S130). Then, the physical network device P sends the log information targeted for the request to the cloud management device 2 as a response (Step S131).

Then, the log/statistical information acquiring unit 35 checks the log information (Step S132) and sends the log information to the log/statistical information management unit 34. Then, the log/statistical information management unit 34 receives the log information, merges the log information acquired from the physical network device 5 before the migration with the log information acquired from the physical network device 5 after the migration, and sorts the merged log information by date and time (Step S133).

Then, the log/statistical information management unit 34 performs conversion, on the basis of the virtual resource information, such that the rule numbers that have different definition identifiers, that are attached in the physical network devices 5 before and after the migration, and that are recorded in the log information can be recognized as the same definition logs (Step S134). Then, the log/statistical information management unit 34 sends the log information to the operation terminal as a response (Step S135). Then, the cloud user GUI unit receives the log information (Step 136) and displays the log information on the display device.

As described above, when the migration of the virtual resource 8 is performed, the log/statistical information management unit 34 merges the log information before the migration with the log information after the migration and performs conversion such that the rule numbers that have different definition identifiers and that are attached in the physical network devices 5 before and after the migration can be recognized as the same definition logs. Accordingly, the log/statistical information management unit 34 can sends log information to the operation terminal as a response in a form that can be easily recognized by a cloud user.

As described above, in the embodiment, the virtual resource information storing unit 21 stores therein information on the physical network device 5 in which each virtual resource 8 is arranged and the physical device information storing unit 22 stores therein the number of remaining definitions of each of the physical network devices 5. If the device management unit 32 is not able to add to the virtual resource 8 arranged in the physical network device 5, the device management unit 32 rearranges the virtual resource 8 to another physical network device by using the virtual resource information storing unit 21 and the physical device information storing unit 22. Accordingly, when the cloud management device 2 adds to the virtual resource 8, a cloud administrator's work is not needed and it is possible to eliminate suspension of the use of the system by the tenant.

Furthermore, in the embodiment, when the migration of the virtual resource 8 is performed, because the log/statistical information management unit 34 creates statistical information on the basis of the information before and after the migration, the holding period, and the conversion method, the cloud management device 2 can display appropriate statistical information for a cloud user.

Furthermore, in the embodiment, when the migration of the virtual resource 8 is performed, the log/statistical information management unit 34 merges the log information before the migration with the log information after the migration and performs conversion such that the rule numbers that have different definition identifiers and that are attached in the physical network devices 5 before and after the migration can be recognized as the same definition logs. Accordingly, the cloud management device 2 can display the log information in a form that can be easily recognized by a cloud user.

Furthermore, in the embodiment, the cloud management device 2 has been described; however, by implementing the configuration held by the cloud management device 2 using software, it is possible to obtain a cloud management program having the same function as that performed by the cloud management device 2. Thus, a computer that executes the cloud management program will be described.

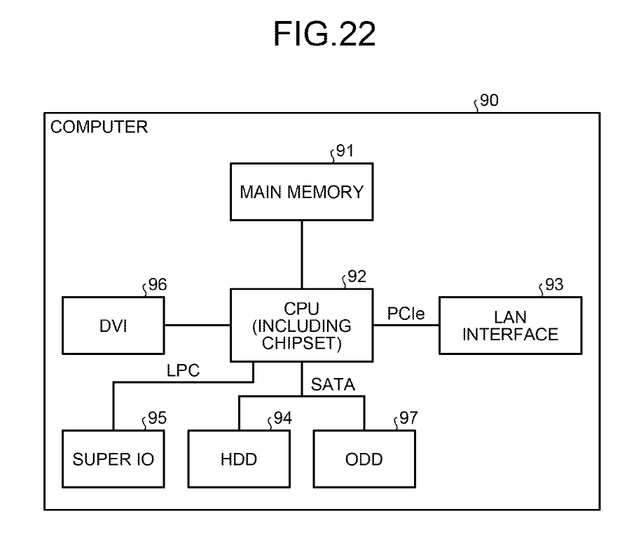

FIG. 22 is a block diagram illustrating a hardware configuration of a computer that executes a cloud management program according to the embodiment. As illustrated in FIG. 22, a computer 90 includes a main memory 91, a central processing unit (CPU) 92, a LAN interface 93, and a hard disk drive (HDD) 94. Furthermore, the computer 90 includes a super input output (IO) 95, a digital visual interface (DVI) 96, and an optical disk drive (ODD) 97.

The main memory 91 is a memory that stores therein programs, intermediate results of the programs, or the like. The CPU 92 is a central processing unit that reads a program from the main memory 91 and executes the program. The CPU 92 includes a chipset that has a memory controller.

The LAN interface 93 is an interface for connecting the computer 90 to another computer via a LAN. The HDD 94 is a disk device that stores therein programs or data and stores therein information in the storing unit 2a illustrated in FIG. 10. The super IO 95 is an interface for connecting an input device, such as a mouse, a keyboard, or the like. The DVI 96 is an interface for connecting a liquid crystal display device and the ODD 97 is a device that reads and writes a DVD.

The LAN interface 93 is connected to the CPU 92 by a PCI Express (PCIe). The HDD 94 and the ODD 97 are connected to the CPU 92 by a serial advanced technology attachment (SATA). The super IO 95 is connected to the CPU 92 by a low pin count (LPC).

Then, the cloud management program executed by the computer 90 is stored in the DVD, is read from the DVD by the ODD 97, and is installed in the computer 90. Alternatively, the cloud management program is stored in databases or the like in another computer system connected via the LAN interface 93, is read from the databases, and is installed in the computer 90. Then, the installed cloud management program is stored in the HDD 94, is read into the main memory 91, and is executed by the CPU 92.

Furthermore, in the embodiment, a description has been given of a case in which physical network device that is not used for multi tenants; however, the present invention is not limited thereto. The present invention may also be used for physical network device for multi tenants or may also be used in a case in which several virtual resources are provided for a single tenant on a single physical network device.

According to an aspect of an embodiment, an advantage is provided in that it is possible to eliminate suspension of the use of the system by the tenant.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A management device comprising:
a determining unit that determines, in a physical network device in which a virtual network device targeted for setting is arranged, whether the number of network definitions that can be used by the virtual network device can be added; and
a rearranging unit that selects, when the determining unit determines that no addition can be made, on the basis of a state of the number of network definitions of the virtual network device targeted for the setting and another virtual network device that is arranged in the physical network device, virtual network device to be migrated to another physical network device and that rearranges the virtual network device arranged in the physical network device.

2. The management device according to claim 1, wherein the rearranging unit selects a physical network device in which the number of network definitions that have not been set is the maximum, determines whether the virtual network device targeted for the setting can be arranged in the selected physical network device, arranges, when the virtual network device targeted for the setting can be arranged, the virtual network device targeted for the rearrangement in the selected physical network device, and allows, when the virtual network device targeted for the setting is not able to be arranged, the virtual network device targeted for the setting to be arranged in the selected physical network device by migrating, to another physical network device, a virtual network device targeted for migration from among one or more virtual network devices arranged in the selected physical network device.

3. The management device according to claim 1, further comprising:
a migration information storing unit that stores therein migration information when a virtual network device is migrated; and
a log management unit that combines, on the basis of the migration information stored in the migration information storing unit, log information before the migration with after the migration and that sends the combined log information to a user of the virtual network device.

4. The management device according to claim 3, wherein, when the log management unit combines the log information before the migration with after the migration, for an identifier of definition information that defines a function of physical network device, the log management unit converts, when different identifiers are attached to the same definition information before and after the migration, the different identifiers to the same identifiers.

5. The management device according to claim 1, further comprising:
a migration information storing unit that stores therein migration information when a virtual network device is migrated;
a conversion information storing unit that stores therein conversion information about statistical information that is converted from statistical information about a virtual network device before and after the migration when the virtual network device is migrated;
a creating unit that creates, on the basis of the migration information stored in the migration information storing unit and the conversion information stored in the conversion information storing unit, statistical information about the migrated virtual network device by performing conversion from the statistical information before and after the migration; and
a sending unit that sends the statistical information created by the creating unit to the user of the virtual network device.

6. A cloud system comprising:
a plurality of physical network devices; and
a management device that manages arrangement of a plurality of virtual network devices into the plurality of physical network devices, wherein
the management device includes
a determining unit that determines, in a physical network device in which a virtual network device targeted for setting is arranged, whether the number of network definitions that can be used by the virtual network device can be added, and
a rearranging unit that selects, when the determining unit determines that no addition can be made, on the basis of a state of the number of network definitions of the virtual network device targeted for the setting and another virtual network device that is arranged in the physical network device, a virtual network device to be migrated to another physical network device and that rearranges the virtual network device arranged in the physical network device.

7. A non-transitory computer-readable storing medium having stored therein a management program that causes a computer to execute a process comprising:
determining, in a physical network device in which a virtual network device targeted for setting is arranged, whether the number of network definitions that can be used by the virtual network device can be added; and
selecting, when it is determined that no addition can be made, on the basis of a state of the number of network definitions of the virtual network device targeted for the setting and another virtual network device that is arranged in the physical network device, a virtual network device to be migrated to another physical network device and rearranging the virtual network device arranged in the physical network device.
